(19) United States
(12) Patent Application Publication
(10) Pub. No.: US 2025/0029212 A1
(43) Pub. Date: Jan. 23, 2025

(54) METHOD AND APPARATUS FOR RESTORING A TARGET RESTORATION REGION IN AN IMAGE

(71) Applicant: SAMSUNG ELECTRONICS CO., LTD., Suwon-si (KR)

(72) Inventors: Mengmeng BAI, Beijing (CN); Jiahui Yuan, Beijing (CN); Xiansong Song, Beijing (CN); Jaekeun Na, Beijing (KR); Changwei Wang, Beijing (CN); Li Zuo, Beijing (CN); Wei Wen, Beijing (CN)

(73) Assignee: SAMSUNG ELECTRONICS CO., LTD., Suwon-si (KR)

(21) Appl. No.: 18/417,629

(22) Filed: Jan. 19, 2024

Related U.S. Application Data
(63) Continuation of application No. PCT/KR23/21738, filed on Dec. 27, 2023.

(30) Foreign Application Priority Data
Jul. 21, 2023 (CN) 202310908012.3

(51) Int. Cl. G06T 5/60; G06T 3/4046; G06T 5/10; G06T 5/50; G06T 5/70; G06T 5/77

(52) U.S. Cl. CPC G06T 5/60; G06T 3/4046; G06T 5/10; G06T 5/50; G06T 5/70; G06T 5/77; G06T 2207/20021; G06T 2207/20056; G06T 2207/20081; G06T 2207/20084; G06T 2207/20221

(57) ABSTRACT

A method may include acquiring a first image that is obtained by adding noise to a second image, the second image comprising a target restoration region. The method may include performing at least one first denoising process on the first image using a first artificial intelligence (AI) network to obtain a first denoising result. The method may include restoring the target restoration region based on the first denoising result using a second AI network to obtain a restored image.

### CROSS-REFERENCE TO RELATED APPLICATIONS

This application is a continuation application of International Application No. PCT/KR2023/021738, filed on Dec. 27, 2023, in the Korean Intellectual Property Office, which is based on and claims priority to Chinese Patent Application No. 202310908012.3, filed on Jul. 21, 2023, in the China National Intellectual Property Administration, the disclosures of which are incorporated by reference herein in their entireties.

### BACKGROUND

### 1. Field

The disclosure relates to image processing, and in particular to a method of restoring a target restoration region in an image.

### 2. Description of Related Art

In the image processing field, image restoration may be directed to images with missing contents, and may be used to generate new contents in regions where image contents are missing in order to restore natural and complete images. However, for many image restoration models, the calculation overhead may be generally high, which may result in low image restoration efficiency.

### SUMMARY

According to an embodiment of the disclosure, a method may include acquiring a first image that is obtained by adding noise to a second image, the second image comprising a target restoration region. The method may include performing at least one first denoising process on the first image using a first artificial intelligence (AI) network to obtain a first denoising result. The method may include restoring the target restoration region based on the first denoising result using a second AI network to obtain a restored image.

According to an embodiment of the disclosure, an electronic device comprising a memory, at least one processer is provided. The one or more processor is configured to execute the instructions to acquire a first image that is obtained by adding noise to a second image, the second image comprising a target restoration region. The one or more processor is configured to execute the instructions to perform at least one first denoising process on the first image using a first artificial intelligence (AI) network to obtain a first denoising result. The one or more processor is configured to restore the target restoration region based on the first denoising result using a second AI network to obtain a restored image.

According to an embodiment of the disclosure, a non-transitory computer-readable storage medium storing instructions is provided. The instructions may be executed by at least one processor, cause the at least one processor to acquire a first image that is obtained by adding noise to a second image, the second image comprising a target restoration region. The instructions may be executed by at least one processor, cause the at least one processor to perform at least one first denoising process on the first image using a first artificial intelligence (AI) network to obtain a first denoising result. The instructions may be executed by at least one processor, cause the at least one processor to restore the target restoration region based on the first denoising result using a second AI network to obtain a restored image.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a flowchart of a method executed by an electronic device according to an embodiment;

FIG. 2A is a schematic diagram of removing noise by a first AI network according to an embodiment;

FIG. 2B is a schematic diagram of a method of training the first AI network according to an embodiment;

FIG. 3A is a schematic diagram of a second AI network according to an embodiment;

FIG. 3B is a schematic diagram of a method of training the second AI network according to an embodiment;

FIG. 4A is a schematic diagram of denoising based on a content feature map according to an embodiment;

FIG. 4B is a schematic diagram of denoising based on a text feature map selected by a user according to an embodiment;

FIG. 4C is a schematic diagram of denoising based on target restoration content related information according to an embodiment;

FIG. 5 is a schematic diagram of processing of an attention module according to an embodiment;

FIG. 6 is a schematic diagram of processing of a first convolution operation according to an embodiment;

FIG. 7 is a schematic diagram of processing of a second convolution operation according to an embodiment;

FIG. 8 is a schematic diagram of a first AI network architecture according to an embodiment;

FIG. 9 is a schematic diagram of a dynamic denoising process exit mechanism according to an embodiment;

FIG. 10 is a schematic diagram of processing by using the second AI network according to an embodiment;

FIG. 11 is another schematic diagram of processing by using the second AI network according to an embodiment;

FIG. 12 is a schematic diagram of processing by using an RT module according to an embodiment;

FIG. 13 is a schematic diagram of processing of a third convolution operation according to an embodiment;

FIG. 14 is a schematic diagram of selecting an object region for removal by the user according to an embodiment;

FIG. 15 is a flowchart of adaptive image clipping according to an embodiment;

FIG. 16 is a flowchart of a complete image restoration process according to an embodiment;

FIG. 17 is a flowchart of a processing process in a user edition stage according to an embodiment;

FIG. 18A is a flowchart of another method executed by an electronic device according to an embodiment;

FIG. 18B is a flowchart of still another method executed by an electronic device according to an embodiment; and

FIG. 19 is a schematic structure diagram of an electronic device according to an embodiment.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein may be made without departing from the scope and spirit of the present disclosure. In addition, descriptions of well-known functions and constructions may be omitted for clarity and conciseness.

The terms and words used in the following description and claims are not limited to the bibliographical meanings, but, are merely used to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces. When a component is said to be “connected” or “coupled” to the other component, the component may be directly connected or coupled to the other component, or it may mean that the component and the other component are connected through an intermediate element. In addition, “connected” or “coupled” as used herein may include wireless connection or wireless coupling.

The term “include” or “may include” may refer to the existence of a corresponding disclosed function, operation or component which may be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B. When describing multiple (two or more) items, if the relationship between multiple items is not explicitly limited, the multiple items may refer to one, many or all of the multiple items. For example, the description of “parameter A includes A1, A2 and A3” may be realized as parameter A includes A1 or A2 or A3, and it may also be realized as parameter A includes at least two of the three parameters A1, A2 and A3.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

At least some of the functions in the apparatus or electronic device provided in embodiments of the present disclosure may be implemented by an artificial intelligence (AI) model. For example, at least one of a plurality of modules of the apparatus or electronic device may be implemented through the AI model. The functions associated with the AI may be performed through a non-volatile memory, a volatile memory, and a processor.

The processor may include one or more processors. At this time, the one or more processors may be general-purpose processors such as a central processing unit (CPU), an application processor (AP), etc., or a pure graphics processing unit, such as a graphics processing unit (GPU), a visual processing unit (VPU), and/or an AI specialized processor, such as a neural processing unit (NPU).

The one or more processors control the processing of input data according to predefined operating rules or AI models stored in the non-volatile memory and the volatile memory. The predefined operating rules or AI models are provided by training or learning.

Here, providing, by learning, may refer to obtaining the predefined operating rules or AI models having a desired characteristic by applying a learning algorithm to a plurality of learning data. The learning may be performed in the apparatus or electronic device itself in which the AI according to embodiments is performed, and/or may be implemented by a separate server/system.

The AI models may include a plurality of neural network layers. Each layer has a plurality of weight values. Each layer performs the neural network computation by computation between the input data of that layer (e.g., the computation results of the previous layer and/or the input data of the AI models) and the plurality of weight values of the current layer. Examples of neural networks include, but are not limited to, a convolutional neural network (CNN), a deep neural network (DNN), a recurrent neural network (RNN), a restricted Boltzmann machine (RBM), a deep belief network (DBN), a bi-directional recurrent deep neural network (BRDNN), generative adversarial networks (GANs), and deep Q-networks.

The learning algorithm is a method of training a predetermined target apparatus (e.g., a robot) by using a plurality of learning data to enable, allow, or control the target apparatus to make a determination or prediction. Examples of the learning algorithm include, but are not limited to, supervised learning, unsupervised learning, semi-supervised learning, or reinforcement learning.

The method provided in the present disclosure may relate to one or more of technical fields such as speech, language, image, video and data intelligence.

In an embodiment, in the image or video field, in accordance with the present disclosure, in the method executed by an electronic device, a method for image restoration may obtain output data for recognizing an image or image features in an image by using image data as input data for an AI model. The AI model may be obtained by training. Here, “obtained by training” means that predefined operating rules or AI models configured to perform desired features (or purposes) are obtained by training a basic AI model with multiple pieces of training data by training algorithms. Embodiments may relate to the visual understanding field of the AI technology. Visual understanding is a technology for recognizing and processing objects like human vision, including, for example, object recognition, object tracking, image retrieval, human recognition, scene recognition, 3D reconstruction/positioning, or image enhancement.

Next, technical solutions of embodiments of the present disclosure and technical effects produced by the technical solutions of embodiments of the present disclosure will be described by referring to some embodiments. It should be noticed that the following embodiments may be referred to, learned from or combined with each other, and the same terms, similar characteristics and similar implementation steps in different embodiments may not be repeated, for convenience of description.

An objective of the embodiments of the present disclosure is to solve the technical problem of low image restoration efficiency.

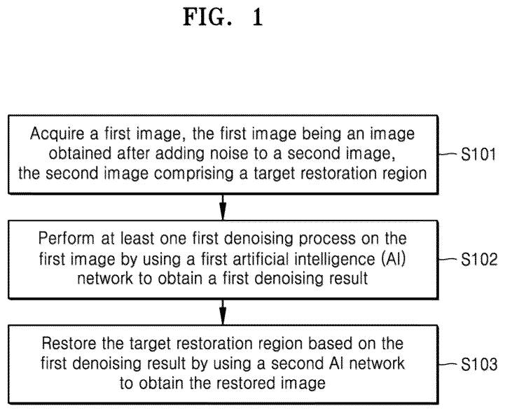

FIG. 1 illustrates a method executed by an electronic device, according to embodiments of the present disclosure.

As shown in FIG. 1, in S101, a first image may be acquired, the first image being an image obtained by adding noise to a second image, the second image including a target restoration region.

In embodiments of the present disclosure, the target restoration region may refer to a region to be restored (or recovered) in an image. For example, the target restoration region may be a missing region or a removal region, but embodiments are not limited thereto. The missing region may refer to a region where some information in the image is missing or damaged due to various factors such as occlusion, blurring and transmission interference. The removal region may refer to a blank region formed by erasing some target objects (such as objects, human beings, buildings, etc.). The erased target objects may be selected automatically or artificially, but embodiments are not limited thereto. In an embodiment, a corresponding mask image may be determined for the target restoration region in order to determine the position of the target restoration region in various images.

In embodiments of the present disclosure, the second image may refer to an image to be restored including a target restoration region. In an embodiment, the second image may directly use the image including the original target restoration region, or the image including the original target restoration region may be subjected to certain processing and then used as the second image for restoration. As an example, if the area of the original target restoration region is too large, the image including the original target restoration region may be clipped to reduce the area of the target restoration region in the sliced image, and the clipped image may be used as a second image for restoration. As an example, if the size of the image including the original target restoration region is too large, the image including the original target restoration region may also be clipped or scaled or deformed to reduce the size of the clipped image, and the clipped image may be used as a second image for restoration. Thus, the calculation amount may be reduced. However, embodiments are not limited thereto.

In embodiments of the present disclosure, the first image may be an image obtained by adding noise to the second image, e.g., fusing the noise with the second image, and the obtained first image may be construed as an image that is completely changed into noise. The added noise may be generated randomly or generated according to a predetermined algorithm, and the fusion mode may be channel splicing, superposition, etc. The process of generating noise and the fusion mode is not specifically limited in embodiments of the present disclosure.

In S102, at least one first denoising process may be performed on the first image by using a first AI network to obtain a first denoising result.

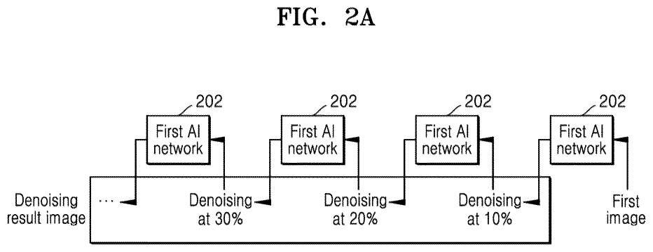

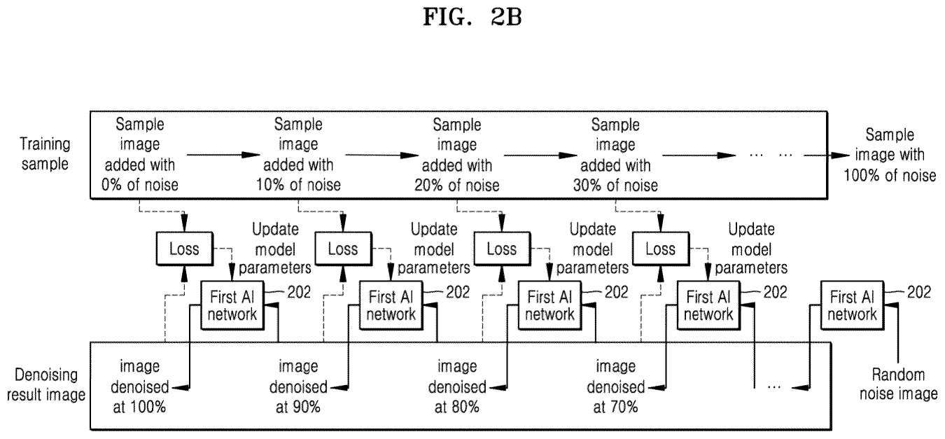

In embodiments of the present disclosure, for the input first image, the noise may be removed by using a first AI network 202 step by step, or for example iteratively, as shown in FIG. 2A. In some embodiments, the first AI network 202 may adopt a diffusion network, but embodiments are not limited thereto. The first AI network 202 may only restore some content at a time, and the current content restoration may be based on the result of previous restoration. In FIG. 2, restoring 10% at a time is taken as an example. In practical applications, the degree of each restoration (also referred to as the timestep of dynamic diffusion denoising) by the first AI network 202 may be achieved by setting different training models according to the actual situation. The degree of each restoration by the first AI network 202 is not specifically limited in embodiments of the present disclosure.

In an embodiment, the first AI network 202 may be trained in by acquiring training samples. Sample images containing the target restoration region may be continuously added with noise and guided to become noise gradually and completely, and the images added with noise every time may be reserved as training samples to calculate the loss in the training state in order to update the first AI network 202. Further, in the process of training the first AI network 202 using the training samples, the first AI network 202 may only be used to predict the noise to be removed in the current input image at each time. For example, as shown in FIG. 2B, an image denoised at 70% may be input into the first AI network, and the first AI network 202 may be used to predict an image denoised at 80% and compare it with the sample image added with 20% of noise to calculate a loss for updating the current model parameter of the first AI network 202. The updated first AI network 202 may be continuously (or iteratively) used for prediction. The similar prediction and model training process may be analogized and is not repeated here.

In embodiments of the present disclosure, the first AI network 202 may transform the image restoration problem into a prediction problem, and it may be necessary to accurately predict the amount of the remaining noise in the current input image and the denoising result during each denoising. If the noise in the image is completely removed, the restored image may be obtained, so that a good restoration effect may be achieved. For example, the first denoising result may include an image that is completely denoised by using the first AI network 202.

In an embodiment, the first denoising result may include an intermediate denoising result after a certain degree of noise is removed by using the first AI network 202. Considering that the first AI network 202 may be continuously used for denoising, the noise in the denoising result may become less, and more sematic contents may be restored. When the content of noise is low to a certain extent, the use of the first AI network 202 may increase the delay of the method. Therefore, a certain determination condition may be set in embodiments of the present disclosure, so that the first AI network 202 may not be continuously used for denoising when the denoising result satisfies the predetermined condition. In practical applications, those skilled in the art may set the predetermined condition according to the actual situation. For example, the amount of the remaining noise reaches a first predetermined value; the image quality (e.g., definition, integrity, etc., but not limited thereto) reaches a second predetermined value; the number of times of denoising processes reaches a third predetermined value; and so on. However, embodiments are not limited thereto.

In S103, the target restoration region may be restored based on the first denoising result by using a second AI network 302 to obtain the restored image.

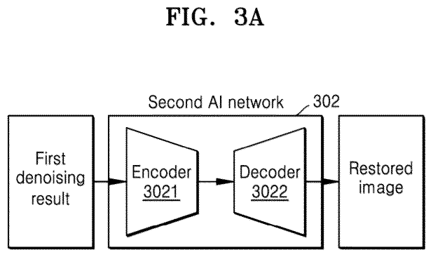

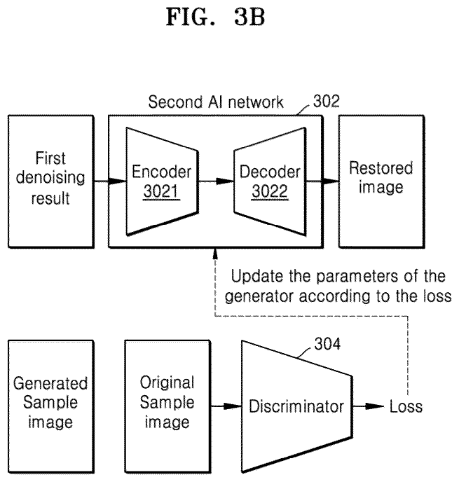

In embodiments of the present disclosure, the second AI network 302 may have a different restoration mode from the first AI network 202. For example, the first AI network 202 may be a network model of a prediction type, and the second AI network 302 may be a network model of a generative type, but embodiments are not limited thereto. The processing process of the network model of the generative type may include expanding an unknown region using the pixels in a known region. In an embodiment, the second AI network 302 may adopt a generative adversarial network (GAN). As an example, the second AI network 302 may be a generator including an encoder 3021 and a decoder 3022, and the restored image may be obtained by inputting the first denoising result into the second AI network 302 for restoration, as shown in FIG. 3A. In the restored image, the target restoration region may be filled with some contents. In an embodiment, the second AI network 302 may be trained according to the loss values of the generated sample image and the original sample image calculated by a discriminator 304, as shown in FIG. 3B. For example, the second AI network 302 and the discriminator 304 may be trained adversarially.

In an embodiment, the type of the second AI network 302 is not limited thereto, and the second AI network 302 may also be or may also include other neural network models. Those skilled in the art may set the type of the second AI network 302 according to the actual situation.

In embodiments of the present disclosure, the first denoising result may have good sematic content, and may have some noise points. The restoration of the second AI network 302 may better maintain the restoration quality of the image, for example, removing noise points other than the sematic content. Moreover, compared with the use of the first AI network 202 alone, the delay may be significantly reduced, and the image restoration efficiency may be improved.

In the method executed by an electronic device provided in embodiments of the present disclosure, the first denoising process may be performed by using the first AI network 202 to obtain the first denoising result, and the first denoising result may then be processed by using the second AI network 302, so that the image restoration efficiency may be obviously improved and the restoration quality of the image may also be maintained.

In embodiments of the present disclosure, before the S102, the method may further include the following steps.

First, a first instruction from a user to select the target restoration region in a third image may be received.

Next, the target restoration region and the second image including the target restoration region may be determined based on the first instruction.

The third image may refer to an image before the target restoration region is removed from the second image.

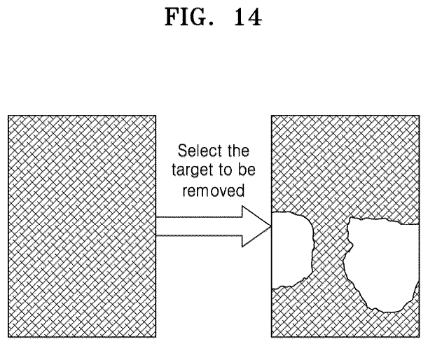

As an example, after the user opens an application to select the third image, an object region to be removed in the third image may be selected. As shown in FIG. 14, after the object region is removed, the second image including the target restoration region may be formed. The removed object region is the target restoration region.

In embodiments of the present disclosure, an implementation for the S102 may include the following steps:

First, target restoration content related information corresponding to the target restoration region is determined. In embodiments, the target restoration content related information may be referred to as target restoration content information.

In embodiments of the present disclosure, the restoration content (or called filling content) for the target restoration region may be settable. In an embodiment, the specific type of the restoration content may be represented by a content feature map. For example, the target restoration content related information may include a content feature map corresponding to the target restoration content. As an example, if the desired restoration content is “Flowers”, the target restoration content related information may be a feature map corresponding to the image containing the content “Flowers”. As an example, if the desired restoration content is a clean background, the target restoration content related information may be a feature map corresponding to the image with the blank content. However, embodiments are not limited thereto. In practical applications, those skilled in the art may set the restoration content and the corresponding target restoration content related information according to the actual situation.

Next, at least one denoising process may be performed on the first image based on the target restoration content related information by using the first AI network 202.

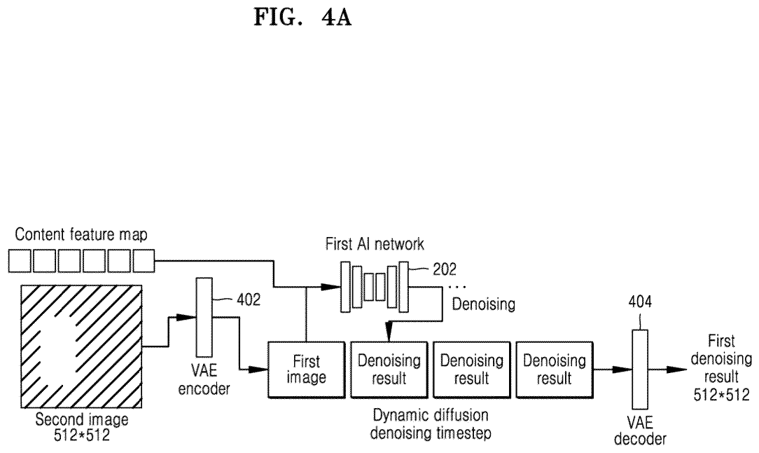

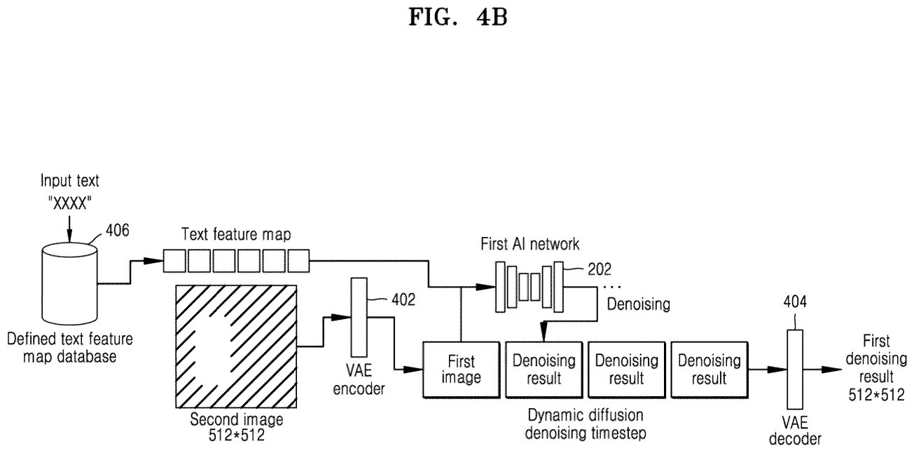

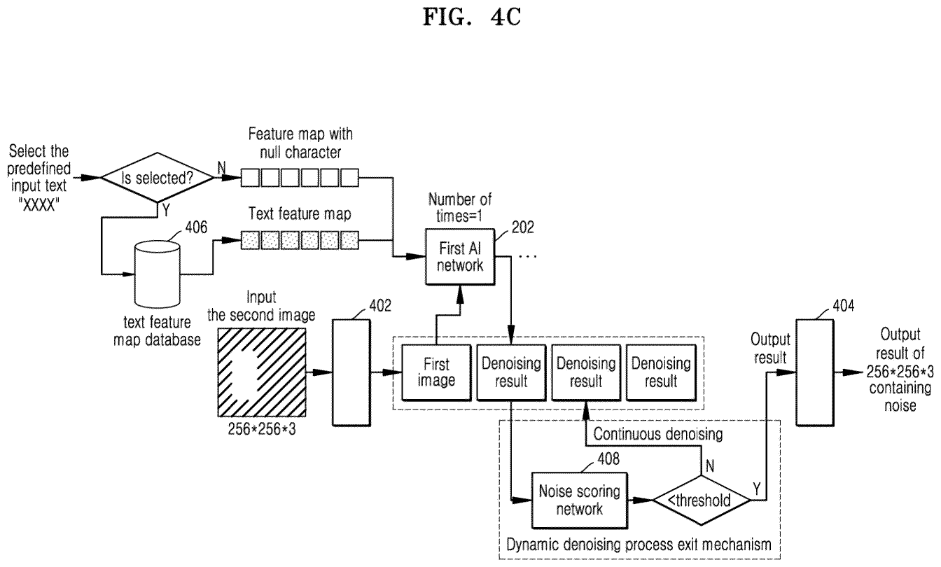

As an example, by taking the target restoration content related information being a content feature map as an example, a process example of performing denoising based on the content feature content is shown in FIG. 4A. This process may specifically include the following. A second image (or scaled second image) may be input into a variational auto-encoder (VAE) encoder 402. In this example, the input size takes 512*512*3 as an example, but embodiments are not limited thereto, and other sizes are also possible (e.g., 256*256*3, which is determined by the set down-sampling multiple, where *3 represents the channel dimension. For convenience of description, the representation of the dimension may be omitted hereinafter. The image of 512*512*3 is compressed to a hidden code space of 64*64*4 using the VAE encoder 402, and the denoising calculation (e.g., the first denoising process) of the first AI network 202 may be performed in this low-dimension space. In embodiments, VAE may not be used. The VAE may include two parts, e.g., VAE encoder 402 and a VAE decoder 404, and may be used to encode an image into a form that is easy to represent, for example, 64*64*4. This form may be settable and may be decoded to the original real image as lossless as possible. A first image may be obtained after noise is added to the image output by the VAE encoder 402. The first image and a content feature map may both be input into the first AI network 202 for the first denoising process, and the first AI network 202 may output a denoising result. The denoising result may be input into the first AI network 202 again for denoising until the target denoising result is output by the first AI network 202 after multiple denoising processes. The target denoising result may be then transformed to a space of 512*512*3 (which is the same as the input size of the VAE encoder 402), so that the first denoising result may be obtained.

In embodiments of the present disclosure, an implementation of the operation of determining target restoration content related information corresponding to the target restoration region may include the following steps.

First, class information of restoration contents may be provided to the user.

Next, a second instruction from the user to select target class information may be received.

Next, target restoration content related information corresponding to the target restoration region may be determined based on the second instruction.

In embodiments of the present disclosure, the second instruction may be a select instruction, for example to provide selectable options to the user, which may correspond to class information of restoration contents, respectively. When the user clicks the option of the target class information, the second instruction from the user to select the target class information may be received.

In an embodiment, the second instruction may also be generated according to the user-defined input operation.

The content type carried by the second instruction may be text, picture, speech, etc. The content type of the second instruction are not limited in embodiments of the present disclosure.

To facilitate understanding, an example is described below in which the second instruction is a select instruction and the content type of the second instruction is text. The processing methods of other content types may be analogized and are not repeated here. Specifically, selectable input texts which correspond to class information of restoration contents may be provided to the user in an interface, and the second instruction from the user to select the target class information may be received. The input text selected by the user may be acquired in response to the second instruction, and the target restoration content related information corresponding to the target restoration region may be determined according to the input text.

In embodiments of the present disclosure, if the target restoration content related information is a content feature map, the target restoration content related information may also be referred to as a text feature map.

In an embodiment, the association relationship between each selectable input text and the corresponding text feature map may be stored by a database. The corresponding text feature map may be searched in the database according to the input text selected by the user.

A process example of denoising based on the texture feature map selected by the user is shown in FIG. 4B. This process may specifically include the following: searching a text feature map corresponding to the input text “XXXX” in the defined text feature map database 406 according to the input text “XXXX” selected by the user, and inputting the text feature map and the first image into the first AI network 202 for the first denoising process. Because the classification of the restoration contents may be fixed and limited, the text feature map may be stored in the database. The process of acquiring the first image and the subsequent processing mode for the first AI network 202 in FIG. 4B may correspond to the description of FIG. 4A and are not repeated here. For example, if the user selects “Flowers”, the restoration content of the target restoration region may contain “Flower”.

In an embodiment, in the operation of determining target restoration content related information corresponding to the target restoration region, if there is no target class information, a feature map with null character may be used as the target restoration content related information.

In embodiments of the present disclosure, the absence of the target class information may mean that the user does not select or input the target class information, or that the user has no desired restoration content. Thus, the restoration content of the target restoration region may be random, so the feature map with null character may be used as the target restoration content related information.

As an example, a process example of denoising based on the target restoration content related information is shown in FIG. 4C. The image restoration system shown in FIG. 4C may include a text feature map database 406, a VAE network (e.g., a VAE encoder 402 and a VAE decoder 404), a first AI network 202 and a noise scoring network 408. The specific process may include the following. The user may select or not select the predefined input text. If the user selects the input text “XXXX”, the text feature map corresponding to the input text “XXXX” may be searched in the text feature map database 406 as the target restoration content related information. If the user does not select any input text, a feature map with null character may be used as the target restoration content related information. The second image (or scaled second image) may be input into a VAE encoder 402. In this example, the input size takes 256*256*3 as an example. The second image may be compressed to a hidden code space of 64*64*4 using the VAE encoder 402, and the denoising calculation (e.g., the first denoising process) of the first AI network 202 may be performed in this low-dimension space. For example, the first image may be obtained after noise is added to the image output by the VAE encoder 402. The content feature map and the first image may both be input into the first AI network 202 for the first denoising process, and the first AI network 202 may output a denoising result. It may be determined by the noise scoring network 408 whether the processing result satisfies the predetermined condition. If the processing result does not satisfy the predetermined condition, the processing result may be input into the first AI network 202 again for the first denoising process. If the processing result satisfies the predetermined condition, the denoising result may be transformed to a space of 256*256*3 by the VAE decoder 404, so that the first denoising result may be obtained. This process may be a dynamic denoising process exit mechanism to solve the problems of high calculation amount and high delay.

In an embodiment, the target restoration content related information may also be generated in real time. For example, the target restoration content related information may be generated in real time according to the user's second instruction by a target restoration content related information generation network. If the user does not perform an operation of selecting the target class information, the generated target restoration content related information may be a feature map with null character. The subsequent processing mode for the target restoration related information generated in real time may be similar to the subsequent processing process in FIGS. 4A and 4C and are not repeated here.

In embodiments of the present disclosure, a fast and lightweight first AI network 202 may be provided, so that the model may be small and the calculation amount may be low, and the problems of large model and high calculation amount generally in denoising models may be solved. In an embodiment, the first AI network 202 includes an attention module, wherein the denoising process may specifically include: by using at least an attention module, calculating the attention between a noise feature map corresponding to the first image and the target restoration content related information through Fourier transform, the attention representing the degree of denoising the noise feature map according to the target restoration content related information, and performing at least one first denoising process on the first image based on the result of attention calculation.

The attention module may be a fast Fourier attention (FFA) module, but embodiments are not limited thereto.

In embodiments of the present disclosure, the target restoration content related information may be input into the first AI network 202 by the FFA, thereby guiding the first AI network 202 to generate the designated content in the target restoration region. Specifically, after the target restoration content related information is merged into the noise feature map corresponding to the first image, the attention module may calculate the attention between two feature maps, and the first AI network 202 may perform specific denoising according to the input operation (e.g., input the text) for the restoration content of the target restoration region. Specifically, the attention module transforms two input feature maps to a frequency domain space through Fourier transform, and then performs attention processing on the transformed feature map to output the processed feature map.

In embodiments of the present disclosure, the calculating the attention between a noise feature map corresponding to the first image and the target restoration content related information through Fourier transform may include the following steps.

First, fast Fourier transform may be performed on the noise feature map corresponding to the first image and the target restoration content related information to obtain a Fourier feature map.

For example, the feature map obtained after merging the target restoration content related information into the noise feature map corresponding to the first image may be transformed from the time domain space to the Fourier space (e.g., the frequency domain space) through fast Fourier transform (FFT). The noise feature map corresponding to the first image may refer to a feature map extracted from the first image, or may refer to a feature map extracted from the denoising result obtained after performing any number of iterations of the first denoising process on the first image by using the first AI network 202.

Next, a first convolution operation may be performed on the Fourier feature map to obtain a Fourier space query feature, a Fourier space key feature and a Fourier space value feature.

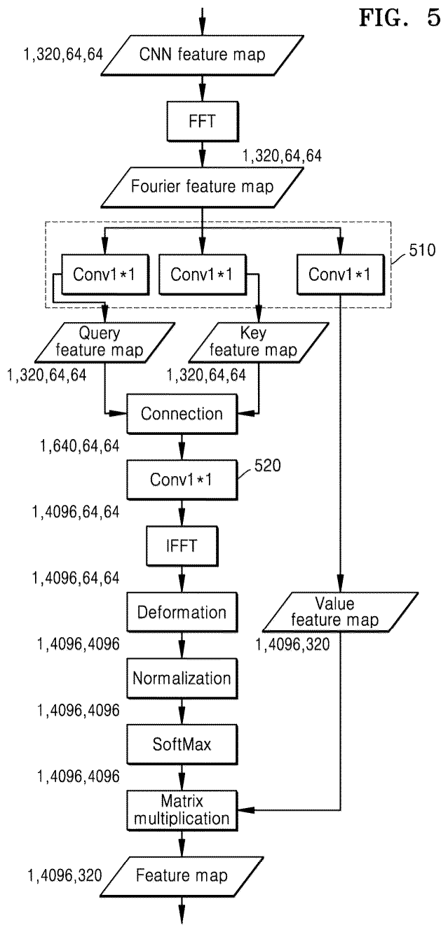

In embodiments of the present disclosure, the first convolution operation may refer to the convolution operation using 1*1 convolution kernel (illustrated for example in FIG. 5 as Conv 1*1). This is because the transformation of the feature map in time domain to the frequency domain space through Fourier transform may realize that each value of the feature map represents the global feature of the image. By performing the convolution operation using 1*1 convolution kernel according to this characteristic, the global feature map information that can only be obtained using the fully connected layer in the time domain space may be obtained.

Next, a second convolution operation may be performed on the Fourier space query feature and the Fourier space key feature to obtain a first attention weight coefficient.

Specifically, the Fourier space query feature and the Fourier space key feature may be connected (e.g., concatenated or Concat) directly, and a second convolution operation may be performed on the connection result.

In embodiments of the present disclosure, the second convolution operation may also refer to the convolution operation using 1*1 convolution kernel (Conv 1*1). In the time domain space, a huge matrix multiplication operation may be needed during the fusion of the Query feature map, the Key feature map and the Value feature map. However, in embodiments of the present disclosure, after the feature map in the time domain space is mapped to the frequency domain space, information of different channels may be mixed in the frequency domain space by the convolution operation using 1*1 convolution kernel, so that the similar effect of matrix multiplication of the Query feature map and the Key feature map may be achieved, and the calculation amount may be reduced.

Next, inverse fast Fourier transform may be performed on the first attention weight coefficient to obtain a second attention weight coefficient.

For example, the first attention weight coefficient may be transformed from the frequency domain space to the time domain space through inverse fast Fourier transform (IFFT) to obtain a second attention weight coefficient.

Next, a result of attention calculation may be obtained based on the second attention weight coefficient and the Fourier space value feature.

The value in the Fourier space value feature may be weighted according to the second attention weigh coefficient to obtain a result of attention calculation as the result of calculation output by the FFA.

In embodiments of the present disclosure, because FFT and IFFT are parameter-free, the time complexity may be ignored compared with other calculation costs, so that the calculation amount brought by FFT and IFFT may be ignored. Therefore, the parameters of the model may be greatly decreased, and the model may be miniaturized.

As an example, a processing example of the attention module is shown in FIG. 5. As shown in FIG. 5 a CNN feature map of dimensions 1, 320, 64, 64 (where 1 represents the number of images, 320 represents the channel dimension, and the channel dimension may be expressed in front or behind as required) may be obtained from the noise feature map corresponding to the first image and the target restoration content related information, and FFT may be performed on the CNN feature map to obtain a Fourier feature map of dimensions 1, 320, 64, 64. Query, Key and Value feature maps of the Fourier space of dimensions 1, 320, 64, 64 with the global receptive field may be calculated by the convolution operation of 1*1 (e.g., a first convolution 510), where the Value feature map may also be expressed in dimensions 1, 4096, 320. The Query and Key feature maps may be merged by the Concat operation in the channel dimension, and the merged feature map of dimensions 1, 640, 64, 64 may then be output to the 1, 4096, 64, 64 dimension by 1*1 convolution to obtain a first attention weight coefficient (e.g., a second convolution 520). Then, the first attention weight coefficient is subjected to IFFT to obtain a result of dimensions 1, 4096, 64, 64 in the time domain space, and the weight coefficients of Query and Key may be processed by transformation, normalization, Softmax or other operations to obtain a second attention weight coefficient of dimensions 1, 4096, 4096. The value in the Value feature map (1, 4096, 320) may be weighted according to the second attention weight coefficient, and the result of calculation of FFA of dimensions 1, 4096, 320 is finally output.

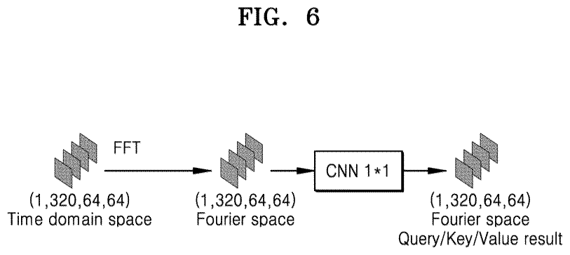

As shown in FIG. 6, because each pixel point in the Fourier space is a receptive field of the whole image region after the feature map is transformed from the time domain space (1, 320, 64, 64) to the Fourier space (1, 320, 64, 64), the Query, Key and Value feature maps (1, 320, 64, 64) in the global receptive field may be calculated by 1*1 convolution (e.g., the first convolution operation). Thus, compared with the fully connected operation in the time domain space, the calculation amount may be greatly reduced.

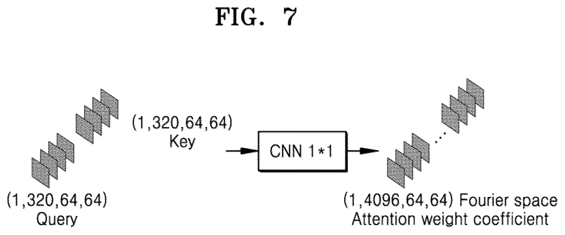

Furthermore, as shown in FIG. 7, the result of matrix multiplication of the Query and Key feature maps in the time domain space may be used as the weight coefficient of the Value feature map to determine which value in the Value feature map is important. Because the feature map of FFA contains global information, the feature map may be calculated in the frequency domain space by channel fusion. Specifically, the Query and Key feature maps of the Fourier space may be merged (or fused) by the concat operation in the channel dimension, and the fused (1, 640, 64, 64) feature map may be output as an attention weight coefficient (1, 4096, 64, 64) by 1*1 convolution (e.g., the second convolution operation). Compared with fusing Query and Key feature maps in the time domain space by huge matrix multiplication, the solution according to embodiments of the present disclosure may greatly reduce the calculation amount.

With regard to the fast and lightweight first AI network 202 provided in embodiments of the present disclosure, the pixel space may be transformed into the Fourier space by using the FFA module, and the value at each position of the feature map may correspond to the features of some image ranges in the pixel space. The 1*1 conv may be used to realize the attention mechanism for transformation, so that the size of the model may be significantly reduced. In addition, the image global receptive field in the Fourier space may be extracted, so that the memory consumption may be reduced. The result of attention calculation similar to the matrix multiplication in the time domain space may be obtained based on the result of CNN attention calculation in the Fourier space, so that the size and delay of the model are reduced.

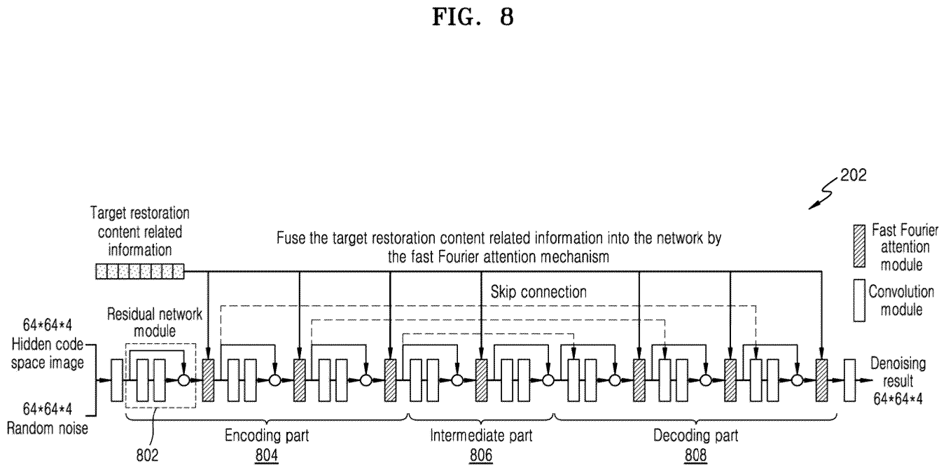

An architecture example of the first AI network 202 is shown in FIG. 8.

As shown in FIG. 8, according to embodiments of the present disclosure, in addition to the attention module, the fast and lightweight first AI network 202 may also include multiple layers of deep residual network modules 802 (e.g., ResNet modules).

The residual network modules 802 may avoid the gradient disappearance or gradient explosion in the training of the first AI network 202 and accelerate the convergence of the model.

Further, the encoding part 804 and the decoding part 808 of the first AI network 202 may include skip connections. The skip connections may effectively utilize the intermediate features of the network layers to solve the problem of gradient disappearance in the case of deeper network layers, and conduce to the reverse propagation of gradient, so that the convergence speed of the model is faster.

Furthermore, an intermediate part 806 may also be included between the encoding part 804 and the decoding part 808 of the first AI network 202. The intermediate part 806 may find the noise points in the first image more accurately.

According to the example illustrated in FIG. 8, a denoising process may include: encoding the second image into an image of 64*64*4 using the VAE encoder 402. A noise data image of a 64*64*4 dimension may be randomly generated. The two images may be spliced in the channel dimension and then input into the first AI network 202, where the first AI network 202 may be a U-net network (a network containing skip connections) composed of multiple layers of residual network modules and FFA. Specifically, one residual network module 802 and one FFA may form a group of modules, and both the encoding part 804 and the decoding part 808 of the first AI network 202 may include the same group (at least one group) of modules. The output result of each group of modules of the encoding part 804 may be connected with a group of modules of the decoding part 808 corresponding to the same scale feature. For example, the X^{th} group of output results of the encoding part may be input into the (N−X+1)^{th} group of the decoding part through the skip connections, where 1≤X≤N. In FIG. 8, both the encoding part 804 and the decoding part 808 may include three groups (N=3) of modules. The output result of the first group of modules (X=1) of the encoding part 804 may be input into the third group of modules (N−X+1=3) of the decoding part 808 through the skip connection; the output result of the second group of modules (X=2) of the encoding part 804 may be input into the second group of modules (N−X+1=2) of the decoding part through the skip connection; and, the output result of the third group of modules (X=3) of the encoding part may be input into the first group of modules (N−X+1=1) of the decoding part through the skip connection. The situation of more or less groups of modules may be analogized and are not repeated here. An intermediate part 806 may also be included between the encoding part 804 and the decoding part 808 of the first AI network 202, and the intermediate part 806 in FIG. 8 may include one residual network module 804, one FFA and one residual network module 804 which are connected. The intermediate part 806 may process the output result of the encoding part 802 and then input it to the decoding part 808. One CNN module may be further included before the encoding part 804 and after the decoding part 808. The CNN module and the residual network module 802 may extract potential spatial noise feature maps. In FIG. 8, the target restoration content related information may be input into the network (merged into the noise feature map) through each FFA. By calculating the attention between two feature maps, the network may be guided to perform a specific denoising process to generate the designated content in the target restoration region.

With regard to the fast and lightweight first AI network 202 provided in embodiments of the present disclosure, the calculation amount and the calculation parameters may be reduced, the efficiency of the model may be improved while maintaining the performance of the model, and the model may be very easy to train.

In embodiments of the present disclosure, in the process of performing at least one first denoising process on the first image by using the first AI network 202 in the S102, specifically, the first denoising process may be successively performed on the first image by using at least one first AI network 202. For example, the first denoising process may be iteratively performed on the first image by using at least one first AI network 202.

For the processing result output by each first AI network 202, a first feature map of the processing result and a second feature map of a third image added with a predetermined proportion of noise may be extracted. The third image may be an image before the target restoration region is removed from the second image, and it may be determined, based on the similarity between the first feature map and the second feature map, whether to continuously use the first AI network 202 for the first denoising process. For example, it may be determined whether each processing result (denoising result) of the first AI network 202 satisfies the predetermined condition. Thus, the dynamic denoising process exit mechanism may be realized.

The third image may refer to an original image in which the target restoration region is not lost or removed. A predetermined proportion of random noise and the third image may be fused, for example, at 30%, to obtain the third image added with the predetermined proportion of noise (which may also be referred to as a fourth image hereinafter, for convenience of description). However, embodiments are not limited thereto, and the value of the predetermined proportion may be set according to the actual situation.

In embodiments of the present disclosure, the first feature map of the processing result may be extracted, the second feature map of the fourth image may be extracted (e.g., the second feature map of a third image added with a predetermined proportion of noise may be extracted), and it may be determined, based on the similarity between the first feature map and the second feature map, whether the noise content of the denoising result is less than the target.

In embodiments of the present disclosure, the operation of extracting the first feature of the processing result may specifically include: by using the third AI network, extracting, from the processing result, first feature maps of at least two layers, and calculating an autocorrelation coefficient of each first feature map.

In embodiments of the present disclosure, the third AI network may be a noise scoring network 408 configured to extract a high-level feature map and calculate the autocorrelation coefficient representing the semantic content and contextual relationship of the feature map. The noise scoring network 408 may be a CNN-based network. For example, it may include multiple layers of connected CNN networks, and each CNN is configured to extract first feature maps of different layers.

In an embodiment, the processing result of the first AI network 202 and the original image including the target restoration region (e.g., the second image) may be input into the noise scoring network 408 to extract first feature maps of different layers. For example, the processing result of the first AI network 202 may include the first denoising result. In an embodiment, a part of the image corresponding to the target restoration region in the denoising result and the original image including the target restoration region (e.g., the second image) may be sliced together to form a first composite image in which the target restoration region contains the content of the denoising result and other regions contain the content of the original image. The first composite image may be input into the noise scoring network 408 to extract first feature maps of different layers. In an embodiment, the target restoration region of the processing result of the first AI network 202 may also be directly input into the noise scoring network 408 to extract first feature maps of different layers.

In an embodiment, the autocorrelation coefficient of each first feature map may be calculated by using a Gram matrix. For example, a symmetric matrix composed of pairwise inner products between k (corresponding to the extracted layers) first feature maps in a multidimensional Euclidean space is used as the autocorrelation coefficients of the k first feature maps, but embodiments are not limited thereto. Other autocorrelation coefficient calculation methods may also be used. The Gram matrix may represent the sematic content and contextual relationship of the image. Therefore, when the result of autocorrelation coefficient calculation is similar to the target, this may indicate that the denoising result has the similar semantic content and channel relationship with the target.

Further, the operation of extracting the second feature map of the third image added with a predetermined proportion of noise may specifically include: by using the third AI network, extracting, from the third image added with a predetermined proportion of noise, second feature maps having at least two layers, and calculating an autocorrelation coefficient of each second feature map.

Specifically, the fourth image and the original image (e.g., the second image) including the target restoration region may be input into the noise scoring network 408 to extract second feature maps of different layers. In an embodiment, a part of the image corresponding to the target restoration region in the fourth image and the original image (e.g., the second image) including the target restoration region may be sliced together to form a second composite image in which the target restoration region contains the content of the predetermined proportion of noise and other regions contain the content of the original image. The second composite image may be input into the noise scoring network 408 to extract second feature maps of different layers. In an embodiment, if each first feature map is extracted by inputting the target restoration region of the processing result of the first AI network 202 into the noise scoring network 408, the target restoration region of the fourth image may also be directly input into the noise scoring network 408 to extract second feature maps of different layers.

In an embodiment, the third AI network used for extracting each first feature map and the third AI network used for extracting each second feature map may be the same, and the used autocorrelation coefficient calculation methods may be the same, so that it is convenient for comparison.

In an embodiment the operation of extracting the second feature map of the third image added with a predetermined proportion of noise may only be executed one time. For example, the autocorrelation coefficient of the second feature map may only be calculated one time, and the result may be directly obtained and used to determine whether to output the first denoising result without further calculation when the result is compared with the autocorrelation coefficient of the processing result of the first AI network 202 next time.

Furthermore, the operation of determining, based on the similarity between the first feature map and the second feature map, whether to continuously use the first AI network 202 for the first denoising process may specifically include: determining a distance between the autocorrelation coefficient of each first feature map and the autocorrelation coefficient of each second feature map; and, determining, based on the relationship between the distance and a first threshold, whether to continuously use the first AI network 202 for the first denoising process.

The distance (e.g., L1 distance) between the autocorrelation coefficient of each first feature map and the autocorrelation coefficient of each second feature map may be calculated, but embodiments are not limited thereto. In an embodiment, if the distance is less than the first threshold, it may be determined that the processing result satisfies the predetermined condition, the first denoising result may be output, and the first AI network 202 is not used for denoising. Otherwise, the first AI network 202 may be continuously used for denoising. In practical applications, those skilled in the art may set value of the first threshold (e.g., 0.1) according to the actual situation.

Based on this, the number of times of performing the first denoising process by the first AI network 202 may be reduced, and the delay of operation may thus be reduced.

In an embodiment, determining whether to continuously use the first AI network 202 for the first denoising process may be combined by multiple determination conditions. As an example, if the number of times of performing the first denoising process by the first AI network 202 does not exceed a predetermined number of times, it may be determined, by using the distance between the autocorrelation coefficients, whether the denoising result satisfies the exit condition; and, if the number of times of performing the first denoising process by the first AI network 202 reaches the predetermined number of times, the denoising process of the first AI network 202 is directly exited. In practical applications, those skilled in the art may set the combination mode of the multiple determination conditions according to the actual situation.

Based on this, it may be dynamically determined whether the intermediate denoising result output by the first AI network 202 satisfies the predetermined exit condition, and the first denoising result may be output after the predetermined exit condition is satisfied. Thus, the timestep and delay may be reduced.

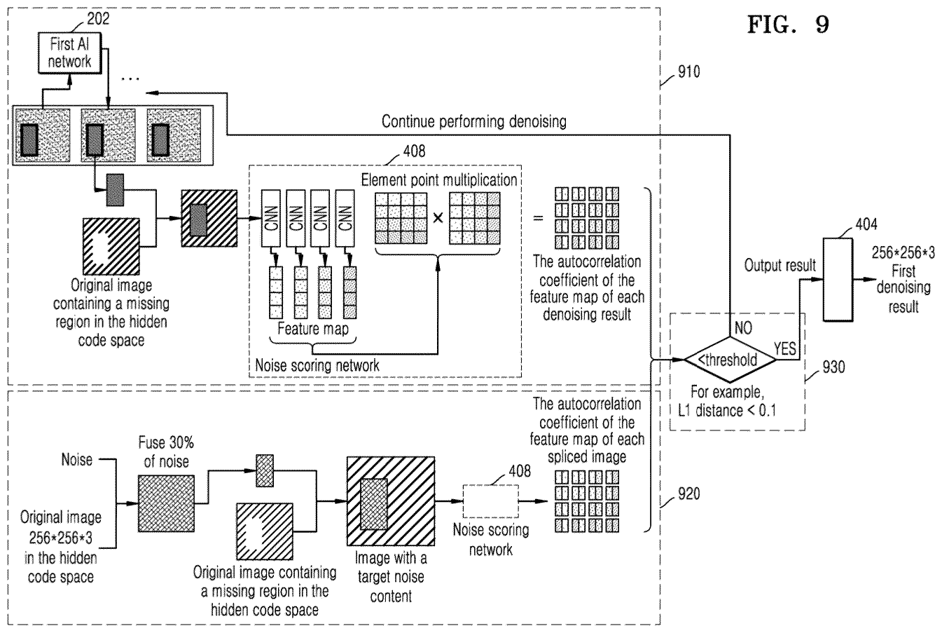

As an example, a process example of the dynamic denoising process exit mechanism is shown in FIG. 9. This process may include the following. At operation 910, a part of the image corresponding to the target restoration region in the processing result (e.g., the denoising result) output by the first AI network 202 may be spliced into the original image containing a missing region (e.g., the target restoration region) (e.g., second image) in the hidden code space of 256*256*3, and the spliced image may be input into the CNN-based noise scoring network 408 (e.g., third AI network) to extract first feature map of different layers. The autocorrelation coefficient of each first feature map (e.g., the feature map of the denoising result) is calculated by using a Gram matrix. At operation 920, the random noise and the original image (e.g., the third image) without missing region (e.g., the target restoration region is not missing) in the hidden code space of 256*256*3 are fused at a predetermined proportion, e.g., 30%. A part of the image corresponding to the target restoration region of the fused image (e.g., the fourth image) and the original image containing a missing region (e.g., the target restoration region) (e.g., the second image) in the hidden code space of 256*256*3 may be spliced together to obtain a spliced image with a target noise content, and the autocorrelation coefficient of each second feature map (e.g., the feature map of the spliced image) may be extracted by the noise scoring network 408. In operation 930 The distance (e.g., L1 distance) between the autocorrelation coefficient of each first feature map obtained in operation 910 and the autocorrelation coefficient of each second feature map (e.g., the spliced image) obtained in operation 920 may be compared. If the distance is less than the first threshold (e.g., 0.1), the result may be output to the VAE decoder 406 to obtain an intermediate first denoising result of 256*256*3. Otherwise, the result may be continuously (or iteratively) input into the first AI network 202 for denoising.

With regard to the denoising exit mechanism provided in embodiments of the present disclosure, the noise scoring network 408 may be used to estimate the denoising result of the first AI network 202. When the denoising result satisfies the requirements, the first denoising result may be output, and this intermediate first denoising result may then be restored by using the second AI network 302. Thus, the operation efficiency may be obviously improved, and the quality of the restored image may also be maintained.

In embodiments of the present disclosure, an implementation for operation S102 may include the following steps.

First, a second denoising process may be performed on the first denoising result to obtain a second denoising result.

In embodiments of the present disclosure, the second denoising process may expand the content of the unknown region (e.g., the remaining noise points in the first denoising result) according to the known region in the first denoising result to remove these remaining noise points in order to obtain the second denoising result (e.g., the fuzzy denoising result).

Next, texture information of the second image may be determined from a region that is not to be restored.

In embodiments of the present disclosure, according to the known region (e.g., the region that is not to be restored) in the second image, the texture information of the second image may be generated by using the texture of the known region to find the appropriate texture.

Next, a third feature map of the target restoration region in the second denoising result may be extracted.

In an embodiment, a fourth convolution operation is performed on the target restoration region in the second denoising result to extract the third feature map.

In an embodiment, the fourth convolution operation may refer to partial convolution. For example, the feature map of the target restoration region in the second denoising result may be extracted by partial convolution.

Next, the target restoration region may be restored based on the texture information and the third feature map to obtain the restored image.

In embodiments of the present disclosure, the texture information may include texture more suitable for the target restoration region. By combining the texture information with the third feature map, an image with better texture may be generated for the target restoration region of the second denoising result, so that the image with the restored target restoration region may be obtained.

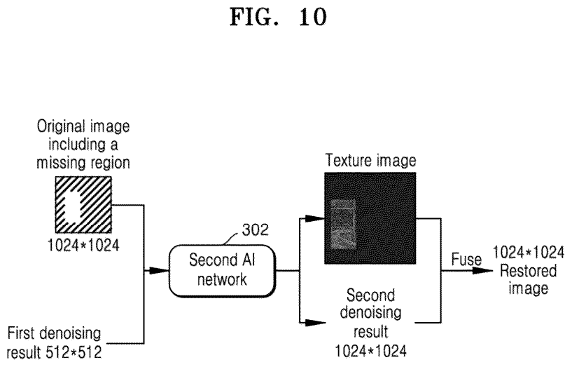

An example of the processing process of the second AI network 302 is shown in FIG. 10. This process may include the following. For example, the original image of 1024*1024 containing a missing region (e.g., the target restoration region) (e.g., the second image) and the first denoising result of 512*512 (or e.g., 256*256) may be input into the second AI network 302 (which may be an improved GAN). The second AI network 302 may perform a second denoising process on the first denoising result to remove the remaining noise points in the first denoising result to obtain a second denoising result of 1024*1024, and the texture information of the second image may be determined according to the known region of the second image, so that a texture image of the target restoration region of the second denoising result may be generated based on the texture information and the third feature map. The second denoising result and the texture image are fused (Add), and the restored image of 1024*1024 is finally output.

In embodiments of the present disclosure, an implementation of the operation of determining the texture information of the second image from a region that is not to be restored may include the following steps.

First, a fourth feature map of at least one previous layer may be extracted from the first denoising result by using the third AI network.

The third AI network used in this operation may be the same as or similar to the third AI network used for extracting the first feature map. The third AI network may be used to extract a shallow-layer feature map of the first denoising result. By directly using the third AI network for extracting the first feature map, certain training resources may be saved. By taking the third AI network including multiple layers of CNN networks which are connected as an example, the shallow-layer feature map may refer to a feature map extracted by first few layers of CNN networks of the third AI network, and may also be referred to as a low-layer feature map or low-level feature map. Compared with a deep-layer feature map, the shallow-layer feature map may contain more texture information. In practical applications, those skilled in the art may set the number of layers corresponding to the desired low-layer feature map according to the actual situation.

Next, a third convolution operation may be performed on the second image and each fourth feature map to determine non-texture information of the second image from a region that is not to be restored.

In embodiments of the present application, the texture information may be a high-frequency feature map, and the non-texture information may be a low-frequency feature map. An image may generally include high-frequency components and low-frequency components. The high-frequency components may correspond to parts with relatively large frequency changes, usually corresponding to information such as the outline and texture of the image, while the low-frequency images may have relatively uniform or very slow frequency changes, usually corresponding to information such as the color of the image.

The third convolution operation may refer to fuzzy convolution, and may specifically include an up-sampling stage and a down-sampling stage. Because the first denoising result (e.g., the fourth feature map) may contain less high-frequency information and the second image may contain more high-frequency information, when the two images are scaled, the original high-frequency information may be released, so that a low-frequency feature map may be obtained.

Next, the texture information of the second image may be determined based on the second image and the non-texture information of the second image.

In embodiments of the disclosure, the extracted shallow-layer feature map may be combined with the second image, and the texture information of the target restoration region of the second denoising result may be generated according to the second image and the known region in the shallow-layer feature map by using the texture restoration of the known region.

In embodiments of the present disclosure, the second AI network 302 may include a denoising branch sub-network and at least one texture enhancement branch sub-network, wherein the denoising branch sub-network may be configured to execute one or more of the above steps.

With regard to the second AI network 302 provided in embodiments of the present disclosure, the denoising branch may be used to eliminate the noise points, and then combined with the shallow-layer feature map of the first denoising result and the known region of the original image including the target restoration region (e.g., the second image) to form rich texture. Finally, the restored image may be output by element point addition. For example, the intermediate first denoising result may be directly transformed into a high-resolution generation result based on the image generation technology, thereby ensuring the image quality of the restored image.

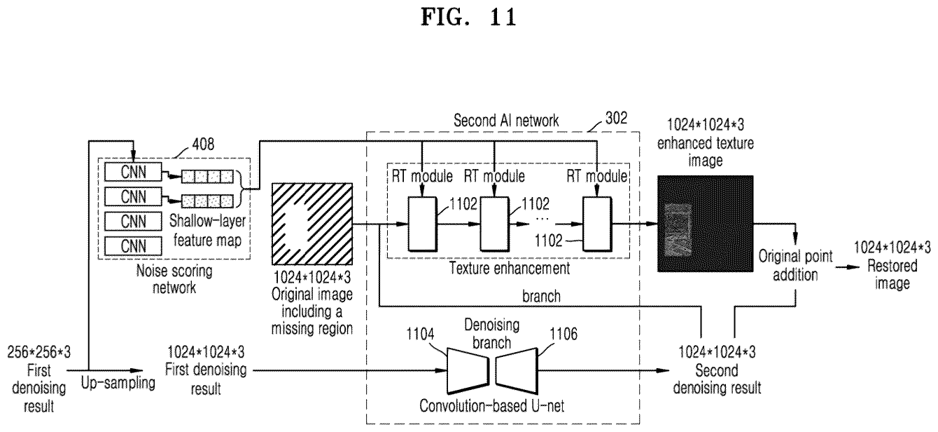

An example of processing process of the second AI network 302 is shown in FIG. 11. This process may include the following. The first denoising result of 256*256*3 (or 512*512*3) is up-sampled as 1024*1024*3 by the VAE decoder 404 and then input into the denoising branch sub-network (which may be the U-net based on convolution, but embodiments are not limited thereto) of the second AI network 302. The remaining noise points in the 1024*1024 image are removed, and the denoising branch sub-network outputs a second denoising result of 1024*1024*3. On the other hand, the first denoising result of 256*256*3 is input into the third AI network (noise scoring network 408) to extract the shallow-layer feature map (e.g., the fourth feature map) of the first denoising result. In FIG. 11, the first two layers are taken as an example. However, in practical applications, embodiments are not limited thereto. The extracted shallow-layer feature map, the original image of 1024*1024*3 including the missing region (e.g., the target restoration region) (e.g., the second image) and the second denoising result of 1024*1024*3 are input into the connected texture enhancement (e.g., a render texture (RT)) branch sub-network, which may be an RT module 1102. The extracted shallow-layer feature map may be input into each texture enhancement branch sub-network (e.g., an RT module 1102), and the last texture enhancement branch sub-network may output an enhanced texture image of 1024*1024*3. The texture image and the second denoising result may be fused (for example, the original elements may be added) to obtain the restored image of 1024*1024*3.

In an example implementation the denoising branch sub-network may adopt a U-net structure including an encoder and a decoder, mainly including a CNN. It may also include a transformer attention model. The input of this branch may be the up-sampling graph of the first denoising result (which may contain noise points) of 1024*1024*3 intermediately output by the first AI network 202. The up-sampling method may be interpolation, but embodiments are not limited thereto. The output may be the second denoising result (which contains no noise point) of 1024*1024*3.

In embodiments of the present disclosure, the noise contained in the first denoising result intermediately output by the first AI network 202 may be removed by an image generation technology, and it may be unnecessary to continuously run the first AI network 202 for multiple times to remove the noise points, so that the quality of the image may be maintained while obviously improving the operation efficiency.

In embodiments of the present disclosure, an implementation of the operation of restoring the target restoration region based on the texture information and the third feature map to obtain the restored image described above may include the following steps.

First, a feature map corresponding to the texture information and the third feature map may be divided into image blocks of the same size to obtain first sub-feature maps and second sub-feature maps.

For example, the high-frequency feature map and the third feature map extracted by partial convolution may be divided into blocks with the same height and width. The specific division size (e.g., the height and width) may be set according to the actual situation, and are not limited in embodiments of the present disclosure.

In embodiments, when the target restoration region has an irregular shape, the total area of the divided second sub-feature maps may cover the irregular target restoration region.

Next, the similarity between each first sub-feature map and each second sub-feature map may be calculated to obtain an adaptive weight corresponding to each pair of first and second sub-feature maps.

In an embodiment, the similarity between each first sub-feature map and each second sub-feature map may be calculated by a cosine similarity algorithm, but embodiments are not limited thereto.

Further, in an embodiment, the result of the similarity calculation may be normalized by a normalization algorithm such as SoftMax to obtain adaptive weights (M×N in total) corresponding to each first sub-feature map (assuming there are M first sub-feature maps) and each second sub-feature map (assuming there are N second sub-feature maps).

Next, each first sub-feature map corresponding to each second sub-feature map may be fused with the corresponding adaptive weight to obtain each texture-enhanced second sub-feature map.

For example, for a second sub-feature map, the M corresponding first sub-feature maps may be fused with the corresponding adaptive weights to obtain a texture-enhanced second sub-feature map. Finally, N texture-enhanced second sub-feature maps are obtained.

For each second sub-feature map, the process of fusing each corresponding first sub-feature map and the corresponding adaptive weight may include, but is not limited to, weighting summation, etc.

Next, the target restoration region may be restored based on each texture-enhanced second sub-feature map to obtain the restored image.

Each second sub-feature map may be used as the high-frequency feature map with the texture-enhanced target restoration region output by one texture enhancement branch network (e.g., a RT module 1102).

Element point addition may be performed on each second sub-feature map and the target restoration region of the second denoising result to obtain the restored image. For example, the high-frequency feature map with the texture-enhanced target restoration region may be fused with the second denoising result (for example, by element point addition, etc.) and then input into a next texture enhancement branch network (e.g., an RT module 1102) together with the second image for further texture enhancement.

Or, for the last texture enhancement branch network (e.g., an RT module 1102), the high-frequency feature map with the texture-enhanced target restoration region may be used as a texture image and fused with the second denoising result (e.g., by element point addition, etc.) to obtain an image with the restored target restoration region.

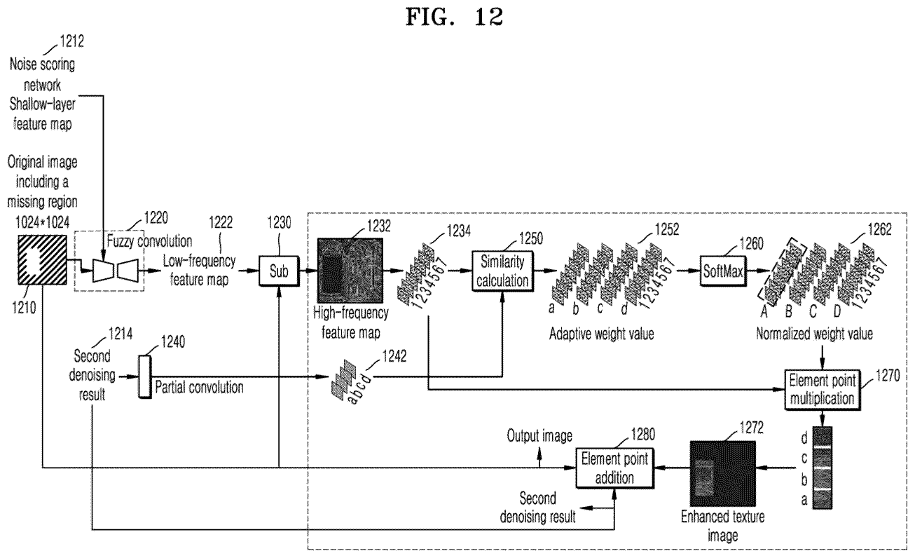

An example of the processing process using the texture enhancement branch network (e.g., an RT module 1102) is shown in FIG. 12. This process may include the following. The original image of 1024*1024 including a missing region (e.g., the target restoration region) (e.g., the second image 1210) may be combined with the shallow-layer feature map output 1212 by the noise scoring network 408 and then subjected to fuzzy convolution 1220 to obtain a low-frequency feature map 1222 (e.g., the non-texture information). Element point subtraction 1230 may be performed on the original image including a missing region (e.g., the target restoration region) (e.g., the second image 1210) and the low-frequency feature map 1222 to obtain a high-frequency feature map 1232 (e.g., the texture information). Also, the third feature map 1242 of the second denoising result is extracted by partial convolution 1240. Further, the high-frequency feature map 1232 and the third feature map 1242 extracted by partial convolution 1240 may be divided into blocks with the same height and width, for example, abcd (for each second sub-feature map) and 1234567 (for each first sub-feature map). The similarity between each abcd second sub-feature map and each 1234567 first sub-feature may be calculated by a cosine similarity algorithm 1250 to obtain an adaptive weight value 1252, and the adaptive weight value 1252 may be normalized (e.g., using SoftMax 1260) to obtain the normalized adaptive weight 1262. The 1234567 position image blocks of the adaptive weights in a group may be multiplied 1270 by each 1234567 first sub-feature map, and all the products may be added to obtain the enhanced a. Similar operations may be performed on the bcd groups. The enhanced abcd may be placed in the target restoration region (other regions may be null) to obtain the texture-enhanced high-frequency feature map (e.g., the enhanced texture image 1272). The second denoising result 1214 is output, and element point addition 1280 may be performed on the second denoising result 1214 and the texture-enhanced high-frequency feature map 1272 to obtain a result map with rich texture in the target restoration region. Then, the original image of 1024*1024 including the target restoration region (e.g., the second image 1210) and the result map with rich texture in the target restoration region may be input into a next texture enhanced branch sub-network, wherein the result map with rich texture in the target restoration region may be used as the second denoising result input by the next texture enhancement branch sub-network.

In embodiments, the texture enhanced branch sub-network (e.g., the RT module 1102) shown in FIG. 12 may correspond to any texture enhancement branch sub-network except for the last texture enhancement branch sub-network shown in FIG. 11. For the last texture enhancement branch sub-network shown in FIG. 11, after the texture-enhanced high-frequency feature map is obtained, the texture-enhanced high-frequency feature map may be directly used the enhanced texture image, and element point addition is performed on the second denoising result and the enhanced texture image to obtain an image with the restored target restoration region.

In the texture enhancement branch sub-network provided in embodiments of the present disclosure, the generation mode of the denoising branch may be simulated by fuzzy convolution to find appropriate high-frequency information. Then, the adaptive weight between the high-frequency feature map and the third feature map of the second denoising result may be learned and calculated. The texture information in the high-frequency feature map may be fused according to the adaptive weight to eventually obtain the texture-enhanced high-frequency feature map. For example, the high-frequency texture of the target restoration region may be restored by using the high-frequency texture of the known region, thereby achieving better texture performance of the restored image.

In embodiments of the present disclosure, the inconsistency between the mode of the fuzzy image in the process of finding high-frequency information and the fuzzy mode of the second denoising result of 1024*1024 obtained by the denoising branch may avoid resulting in the mismatch of the obtained high-frequency image and affecting texture enhancement. Therefore, in embodiments of the present disclosure, the low-frequency feature map is extracted by the third convolution operation (e.g., fuzzy convolution). The fuzzy convolution contains a small U-net with a down-sampling stage and an up-sampling stage. Specifically, the third convolution operation may include: performing a corresponding number of down-sampling operations and up-sampling operations on the second image to obtain non-texture information of the second image, wherein, for at least one down-sampling operation, element point averaging may be performed on the result of down-sampling and the fourth feature map of the corresponding scale to obtain an average feature map, and a next down-sampling operation or up-sampling operation may be performed on the average feature map.

The number of the down-sampling operations and the up-sampling operations may be set according to the actual situation, and are not limited in embodiments of the present disclosure. In an embodiment, in the down-sampling stage, down-sampling may be performed by a convolution layer with a step of 2 or by other pooling operations; and, in the up-sampling stage, up-sampling may be performed by convolution and interpolation or by deconvolution with a step of 2. However, embodiments are not limited thereto.

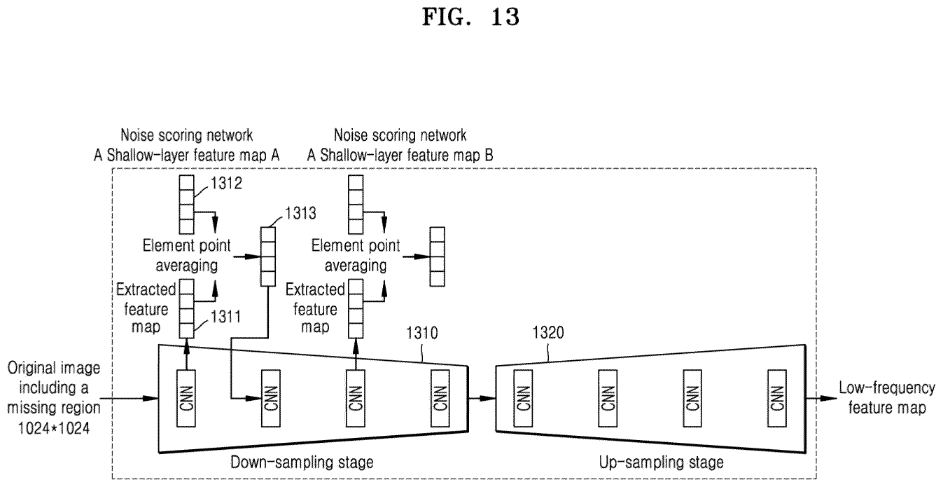

Taking 4 down-sampling operations and 4 up-sampling operations as an example, an example of the processing process of the third convolution operation (e.g., fuzzy operation) is shown in FIG. 13. This process may include the following. The original image of 1024*1024 including a missing region (e.g., the target restoration region) (e.g., the second image) may be input to the down-sampling stage 1310, and 4 down-sampling operations may be performed by 4 CNN layers in the down-sampling stage. After the down-sampling operations in the first and third layers (which may be settable, but embodiments are not limited thereto) have extracted a feature map 1311, a feature average value 1313 of each element point may be calculated for the extracted feature map 1311 and the shallow-layer feature map 1312 output by the third AI network (e.g., the noise scoring network 408) of the corresponding scale to obtain an average feature map 1313, and the average feature map 1313 may be input to the next CNN layer for the next down-sampling operation. The result of the down-sampling stage 1310 may be input to the up-sampling stage 1320 to eventually obtain the low-frequency feature map (e.g., the non-texture information).

In embodiments of the present disclosure, after the feature image of the second image and the shallow-layer feature map from the noise scoring network 408 are averaged by fuzzy operation, the fuzzy convolution may adopt a fuzzy mode similar to that used by the image generated from the first denoising result by the denoising branch of the second AI network 302, and more reasonable high-frequency feature map may thus be obtained.

In embodiments of the present disclosure, before acquiring the first image, the method of FIG. 1 may further include the following preprocessing steps.

First, a fifth image including the target restoration region may be acquired.

The fifth image may be obtained by removing an object region selected by the user from the third image (e.g., the original image), or may be an image in which some information is missing or the original image is damaged due to various factors such as occlusion, blurring or transmission interference, etc. However, embodiments are not limited thereto.

Next, if the size of the fifth image is greater than a second threshold, the second image may be acquired from the fifth image in at least one of the following clipping processes.

According to a first clipping process, if the area of the target restoration region is less than a third threshold and the length of the target restoration region is less than a fourth threshold, the fifth image may be clipped into an image with a size equal to the second threshold by using the target restoration region as a center in order to obtain the second image.

The area or size of the target restoration region may be determined according to the corresponding mask image.

Specifically, when the area of the target restoration region is less than the third threshold (e.g., 1024*1024*80%) and the length of the target restoration region is less than the fourth threshold (e.g., 1024), for example when the target restoration region is relatively small, the original image may be clipped into an image with a size equal to the second threshold (e.g., 1024*1024) by using the center of the target restoration region as a center, and this image may be then input to the subsequent image restoration process.

In an embodiment, if the target restoration region is closer to the edge of the fifth image, a region outside the image may be contained in the clipping process using the center point of the target restoration region as a center. Thus, the clipped region may be translated into the fifth image, or the fifth image may be subjected to mirror finishing and then clipped.

According to a second clipping process, if the area of the target restoration region is less than the third threshold and the length of the target restoration region is greater than the fourth threshold, or if the area of the target restoration region is greater than the third threshold, an image region in the fifth image where the size of the image region is the second threshold and the area of the target restoration region in this image region is not greater than a fifth threshold may be determined, the image region may be clipped to obtain the second image, and the target restoration region in the image region may be used as the target restoration region of the second image.

Specifically, if the area of the target restoration region is less than the third threshold (e.g., 1024*1024*80%) and the length of the target restoration region is greater than the fourth threshold (e.g., 1024) (e.g., when the target restoration region is relatively elongated), or if the area of the target restoration region is greater than the third threshold (e.g., when the target restoration region is relatively large), an image region in the fifth image where the size of the image region is the second threshold (e.g., 1024*1024) and the area of the target restoration region in this image region is not greater than the fifth threshold (e.g., 1024*1024*80%) may be determined.

In an embodiment, from left to right and from top to bottom (or in other orders), a matrix region (e.g., the image region) with a size equal to the second threshold (e.g., 1024*1024) is found, where the area of the target restoration region in this region is equal to or less than the fifth threshold (e.g., 1024*1024*80%). This region may be clipped and input to the subsequent image restoration process.

Further, in the latter case, the method may further include steps of: fusing the image with the restored target restoration region corresponding to the image region into the fifth image to obtain a fifth image with the updated target restoration region; and, acquiring the second image from the fifth image with the updated target restoration region in at least one of the clipping processes.

For example, in the case where the target restoration region is relatively elongated or large, it may be unable to fill all target restoration regions by one clipping operation. Thus, the image restored by the previously clipped region may be pasted back to the original fifth image, the target restoration region and its mask image may be updated, and the image may be adaptively clipped continuously according to the same process and then input to the subsequent image restoration process.

According to a third clipping process, if the size of the fifth image is less than the second threshold, depending upon the situation of the model, the fifth image may be directly input to the subsequent image restoration process, or the fifth image may be subjected to mirror finishing and then clipped in the first clipping process to obtain a second image and the second image may be input to the subsequent image restoration process.

For the clipped image, the image with the restored clipped region may be pasted back to the fifth image to obtain the final restored image.

In practical applications, those skilled in the art may set the values of the second threshold, the third threshold, the fourth threshold and the fifth threshold according to the actual situation, and are not limited in embodiments of the present disclosure.

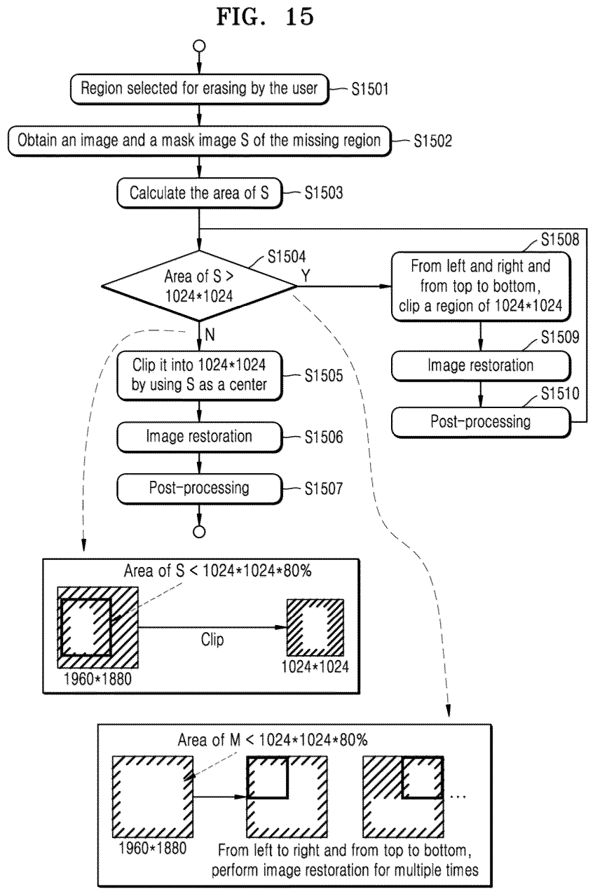

An example of the processing process of adaptive image clipping may be shown in FIG. 15. This process may include the following.

According to the user's selection operation at operation S1501 to select the object region for erasing, a fifth image including a missing region (e.g., the target restoration region) and a mask image S corresponding to the missing region may be obtained at operation S1502. The area of the mask image S may be calculated at operation S1503.

When the area of S is determined to be less than the third threshold (e.g., 1024*1024*80%) at operation S1504, the original image may be clipped at operation S1505 into an image with a size equal to the second threshold (e.g., 1024*1024) by using S as a center, and this image may be input to the subsequent image restoration process at operation S1506 and post-processing at operation S1507.

When the area of S is determined to be greater than the third threshold (e.g., 1024*1024*80%) at operation S1504, from left to right and from top to bottom, a matrix region (e.g., the image region) with a size equal to the second threshold (e.g., 1024*1024) may be found at operation S1508, where the area of the missing region in this region is equal to or less than the fifth threshold (e.g., 1024*1024*80%). This region may be clipped and then input to the subsequent image restoration process at operation S1509 and post-processing at operation S1510. The image with the restored region may be pasted back to the original fifth image, and the mask image S may be updated.

If the updated S is less than the third threshold (e.g., 1024*1024*80%), operations S1505 through S1507 are executed again; otherwise, the operations S1508 through S1510 are executed again. The same subsequent processing process may not be repeated.

In embodiments of the present disclosure, the model may process high-resolution images (for example, images with pixels exceeding the second image (e.g., 1024*1024)) by adaptive image clipping, so that the problem of insufficient memory when the model processes images with pixels exceeding the second threshold may be avoided, and the problem that high-resolution images cannot be run in a terminal due to large calculation amount may be solved.

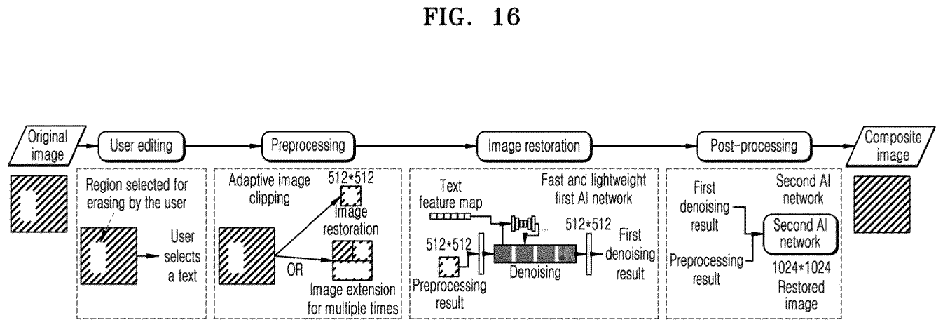

Based on at least one of the above embodiments, in embodiments of the present disclosure, FIG. 16 shows an example of a complete image restoration process. Specifically, the process may include the following. An original image may be acquired. In a user editing stage, the user may select an erased or missing region and select a restoration content (e.g., by text) to guide the model to generate the corresponding content. In a preprocessing stage, adaptive image clipping may be performed according to the proportion of the missing region (e.g., the target restoration region) to the original image. In an image restoration stage, the corresponding text feature map may be found in the database according to the text selected by the user, and the corresponding text feature map and the preprocessing result may be input into the fast and lightweight first AI network 202 for denoising. The first denoising result may be output in combination with the dynamic denoising exit mechanism. In a post-processing stage, the first denoising result and the preprocessed image may be input into the second AI network 302, and the restored image with a resolution of 1024*1024 may be output by fuzzy denoising and texture enhancement. The restored image may be pasted back to the original image to obtain the final restored image.

The fast and lightweight first AI network 202 may transform the feature map from the time domain space to the Fourier space and extract the receptive field of the image range in the Fourier space, so that the attention operation of multiplying many matrices in the time domain space may be replaced with the lightweight and fast CNN-based method, and the size of the model may be obviously reduced.

In the dynamic denoising exit mechanism, the autocorrelation coefficient of the first feature map may be calculated based on the noise scoring network 408 (e.g., the third AI network). This autocorrelation coefficient may consider the sematic content and context relationship of the denoising result. When the autocorrelation coefficient reaches the defined threshold, the intermediate first denoising result satisfying the requirements may be dynamically output, thereby avoiding a large amount of denoising processes and significantly improving the efficiency.

In combination with the second AI network 302, the first AI network 202 may simulate the generation mode of the denoising branch by fuzzy convolution, so that more appropriate high-frequency information may be found to assist the target restoration region to generate a better high-frequency image. Then, the high-frequency information of the known region may be used to enrich the first denoising result, thereby ensuring the image quality.

The specific implementation of each processing stage may refer to the above description and are not repeated here.

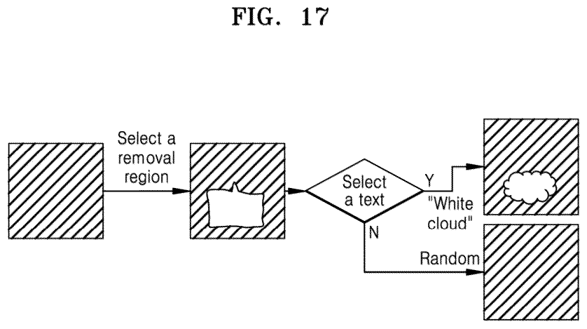

An example processing process of the user editing stage is shown in FIG. 17, and may include: selecting a target to be removed, that is, selecting an object region or a user-defined region as a removal region according to the user's operation. Further, the content to be restored in the removal region may be selected. If the user selects a text (in this example, the text is “White cloud”), the text feature map corresponding to the input text may be input for preprocessing, and the image related to the selected text may be finally restored. As another example, if the user selects the filling content “Flowers”, the removal region may be filled with the content of “Flowers”. If the user does not select any text, the image of the target restoration region may be randomly restored.

In the method executed by an electronic device provided in embodiments of the present disclosure, the target (e.g., an object, a human being, etc.) in the image is erased by the AI generation technology, and the specified new target or background or other content may be generated in the erased target region.

Compared with image restoration directly using the adversarial trained GAN network, by the image restoration method provided in embodiments of the present disclosure, it may be easier for the network to converge to a good or acceptable state; and for an image with a large-area missing area (e.g., the target restoration region), the restoration content may be more diversified, more natural and more reasonable.

Compared with image restoration directly using the diffusion network, by the image restoration method provided in embodiments of the present disclosure, it may be unnecessary to use a large amount of transformer structures (which may be characterized by many model parameters, large models and high calculation amount) to calculate global features, thereby realizing less model parameters, smaller models and lower calculation amount. Moreover, by using the dynamic denoising process exit mechanism, the model may require less operation time, the delay may be obviously reduced, the operation efficiency may be higher, and it may be more convenient to run in a mobile terminal device.

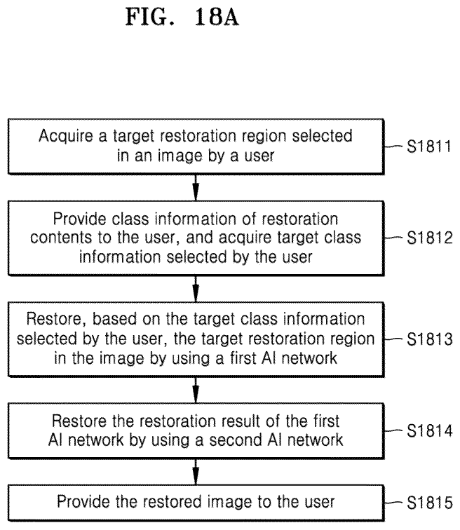

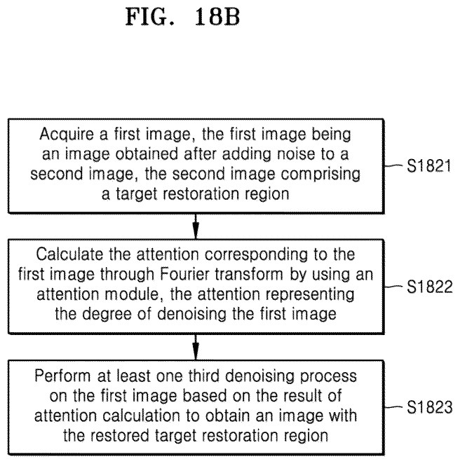

FIG. 18A is a flowchart of a method executed by an electronic device, according to embodiments of the present disclosure. As shown in FIG. 18A, in operation S1811, a target restoration region selected in an image by a user may be acquired.

In embodiments of the present disclosure, the user may select an object region to be removed in an image. As shown in FIG. 14, after the object region is removed, the above second image including the target restoration region may be formed. The removed object region may be the target restoration region.

In operation S1812, class information of restoration contents may be provided to the user, and target class information selected by the user is acquired.

In embodiments of the present disclosure, selectable options may be provided to the user, and correspond to class information of restoration contents, respectively. When the user clicks the option of the target class information, an instruction (e.g., the above second instruction) from the user to select the target class information may be received.

In operation S1813, the target restoration region in the image may be restored based on the target class information selected by the user by using a first AI network 202.

In an embodiment, an image added with noise (e.g., the above first image) may be acquired, and at least one first denoising process may be performed on the target restoration region in the image added with noise based on the target class information selected by the user by using the first AI network 202.

Specifically, target restoration content related information corresponding to the target restoration region may be determined based on the target class information selected by the user, and then the target restoration region in the image may be restored based on the target restoration content related information by using the first AI network 202.

In embodiments of the present disclosure, the first AI network 202 may be a diffusion network. The target restoration region in the image may be restored step by step by using the first AI network 202. The processing mode and the training mode of the first AI network 202 may refer to the above description and are not repeated here.

In operation S1814, the restoration result of the first AI network 202 may be restored by using a second AI network 302.

The restoration result of the first AI network 202 may be the above first denoising result.

In embodiments of the present disclosure, the second AI network 302 may have a different restoration mode from the first AI network 202. For example, the second AI network 302 may be a GAN network, and the processing process may include expanding pixels of a known region to an unknown region. However, embodiments are not limited thereto. The processing mode and the training mode of the second AI network 302 may refer to the above description and are not repeated here.

In operation S1815, the restored image may be provided to the user.

The method executed by an electronic device provided in embodiments of the present disclosure may be the target restoration content related information corresponding to the restoration content of the target restoration region, the fast and lightweight denoising network and the dynamic denoising process exit mechanism described above or other processing modes to realize image restoration. The specific functional description and the achieved beneficial effects may specifically refer to the description of the corresponding method shown above and are not repeated here.

FIG. 18B is a flowchart of a method executed by an electronic device, according to embodiments of the present disclosure.

As shown in FIG. 18B, in operation S1821, a first image may be acquired, the first image being an image obtained after adding noise to a second image, the second image including a target restoration region.

In embodiments of the present disclosure, the target restoration region may refer to a region to be restored (or recovered) in an image. For example, it may be a missing region or a removal region, but embodiments are not limited thereto. The missing region may refer to a region where some information in the image is missing or damaged due to various factors such as occlusion, blurring and transmission interference. The removal region may refer to a blank region formed by erasing some target objects (such as objects, human beings, buildings, etc.). The erased target objects may be selected automatically or artificially, but embodiments are not limited thereto. In an embodiment, a corresponding mask image may be determined for the target restoration region in order to determine the position of the target restoration region in various images.

In embodiments of the present disclosure, the second image may refer to an image to be restored including a target restoration region. In an embodiment, the second image may directly use the image including the original target restoration region, or the image including the original target restoration region may be subjected to certain processing and then used as the second image for restoration. As an example, if the area of the original target restoration region is too large, the image including the original target restoration region may be clipped to reduce the area of the target restoration region in the sliced image, and the clipped image may be used as a second image for restoration.

As an example, if the size of the image including the original target restoration region is too large, the image including the original target restoration region may also be clipped or scaled or deformed to reduce the size of the clipped image, and the clipped image may be used as a second image for restoration. Thus, the calculation amount may be reduced.

In embodiments of the present disclosure, the first image may be an image obtained after adding noise to the second image, e.g., fusing the noise with the second image, and the obtained first image include an image that is completely changed into noise. The added noise may be generated randomly or generated according to a predetermined algorithm, and the fusion mode may be channel splicing, superposition, etc. The process of generating noise and the fusion mode are not specifically limited in embodiments of the present disclosure.

In operation S1822, the attention corresponding to the first image may be calculated through Fourier transform by using an attention module, the attention representing the degree of denoising the first image.

The attention module may be an FFA module, but embodiments are not limited thereto.

In embodiments of the present disclosure, the attention module may calculate the self-attention of the first image, which may be used to perform specific denoising on the target restoration region based on the information of the first image itself.

In operation S1823, at least one third denoising process may be performed on the first image based on the result of attention calculation to obtain an image with the restored target restoration region.

In embodiments of the present disclosure, the input first image may be denoised step by step or iteratively, for example only a little content may be restored at one time and the current content restoration is based on the result of previous restoration. With the continuous denoising based on the result of attention calculation, the noise in the denoising result may become less, and more sematic contents may be restored, until the denoising is completed and the image with the restored target restoration region is obtained.

In embodiments of the present disclosure, an implementation for the operation S1802, for example, the calculating the attention corresponding to the first image through Fourier transform, may include the following steps.

First, fast Fourier transform may be performed on a noise feature map corresponding to the first image to obtain a Fourier feature map.

For example, the noise feature map corresponding to the first image may be transformed from a time domain space to a Fourier space (e.g., the frequency domain space). The noise feature map corresponding to the first image may refer to a feature map exacted from the first image, or may refer to a feature map extracted from the denoising result obtained after performing any number of the first denoising process on the first image.

Next, a first convolution operation may be performed on the Fourier feature map to obtain a Fourier space query feature, a Fourier space key feature and a Fourier space value feature.

In embodiments of the present disclosure, the first convolution operation may refer to the convolution operation using 1*1 convolution kernel (Conv 1*1). This is because the transformation of the feature map in time domain to the frequency domain space through Fourier transform may realize that each value of the feature map represents the global feature of the image. By performing the convolution operation using 1*1 convolution kernel according to this characteristic, the global feature map information that may only be obtained using the fully connected layer in the time domain space may be obtained.

Next, a second convolution operation may be performed on the Fourier space query feature and the Fourier space key feature to obtain a first attention weight coefficient.

Specifically, the Fourier space query feature and the Fourier space key feature may be connected (e.g., concatenated or Concat) directly, and a second convolution operation is performed on the connection result.

In embodiments of the present disclosure, the second convolution operation may also refer to the convolution operation using 1*1 convolution kernel (e.g., Conv 1*1). In the time domain space, a huge matrix multiplication operation may be needed during the fusion of the Query feature map, the Key feature map and the Value feature map. However, in embodiments of the present disclosure, after the feature map in the time domain space is mapped to the frequency domain space, information of different channels may be mixed in the frequency domain space by the convolution operation using 1*1 convolution kernel, so that the similar effect of matrix multiplication of the Query feature map and the Key feature map may be achieved, such that the calculation amount is reduced.

Next, inverse fast Fourier transform is performed on the first attention weight coefficient to obtain a second attention weight coefficient.

For example, the first attention weight coefficient may be transformed from the frequency domain space to the time domain space through inverse fast Fourier transform (IFFT) to obtain a second attention weight coefficient.

Next, a result of attention calculation may be obtained based on the second attention weight coefficient and the Fourier space value feature.

The value in the Fourier space value feature may be weighted according to the second attention weigh coefficient to obtain a result of attention calculation as the result of calculation output by the FFA.

In embodiments of the present disclosure, because FFT and IFFT are parameter-free, the time complexity may be ignored compared with other calculation costs, so that the calculation amount brought by FFT and IFFT may be ignored. Therefore, the parameters of the model may be greatly decreased, thus the model may be miniaturized.

In the image restoration method provided in embodiments of the present disclosure, a fast and lightweight first AI network 202 may be used, so that the model is small and the calculation amount is low, and the problems of large model and high calculation amount generally in denoising models may be solved.

The fast and lightweight denoising network provided in embodiments of the present disclosure may be used in the first AI network 202, and may be combined with the target restoration content related information corresponding to the restoration content of the target restoration region, the dynamic denoising process exit mechanism and the second AI network 302 to realize image restoration. The specific functional description and the achieved beneficial effects may refer to the description of the corresponding method shown above and are not repeated here.

The fast and lightweight first AI network 202 provided in embodiments of the present disclosure may have a remarkable effect in reducing the calculation amount, and the fast Fourier attention module may significantly reduce the calculation parameters and calculation amount of the model.

The combination of the dynamic denoising process exit mechanism and the second AI network 302 provided in embodiments of the present disclosure may have a remarkable effect in improving the operation efficiency, the size of the model may be obviously reduced, and the operation time may be obviously reduced.

In addition, some diffusion networks may process 512*512 images, while the processing results of 1024*1024 images need to be enlarged by interpolation, thus resulting in blur. In addition, for a large target restoration region, there may be lots of artifacts in the restoration result of some GAN networks. Compared with the image restoration result of some diffusion networks for a 1024*1024 image, embodiments of the present disclosure may have clearer and more natural restoration effects; and, compared with the image restoration result of some GAN networks, the restoration content according to embodiments of the present disclosure may be more diversified, more natural and more reasonable.

The image restoration method provided in embodiments of the present disclosure may be used to infer the content of the target restoration region after the image is rotated, may be used to generate perspective images and used for restoring super-resolution images, but not limited thereto.

The technical solutions provided in embodiments of the present disclosure may be applied to various electronic devices, including but not limited to, mobile terminals, intelligent terminals, etc., for example, smart phones, flat computers, notebook computers, intelligent wearable devices (e.g., watches, glasses, etc.), smart speakers, vehicle-mounted terminals, personal digital assistants, portable multimedia players, navigation apparatuses, but not limited thereto. It should be understood by those skilled in the art that, except for the elements special for mobile purpose, the configurations according to embodiments of the present disclosure may also be applied to a fixed type of terminals, such as digital television (TV) sets or desktop computers.

The technical solutions provided in embodiments of the present disclosure may also be applied to image restoration in servers, such as separate physical servers, which may be server clusters or distributed systems composed of multiple physical servers, or may be cloud servers that provide basic cloud computing services such as cloud services, cloud databases, cloud computing, cloud functions, cloud storage, network services, cloud communication, middleware services, domain name services, security services, content delivery networks (CDNs) and big data and artificial intelligent platforms.

Specifically, the technical solutions provided in embodiments of the present disclosure may be applied to image AI edition applications on various electronic devices to improve the image restoration performance of large-area target restoration regions.

The embodiments of the present disclosure further comprise an electronic device comprising a processor and, in an embodiment, a transceiver and/or memory coupled to the processor configured to perform the steps of the method provided in any of the optional embodiments of the present disclosure.

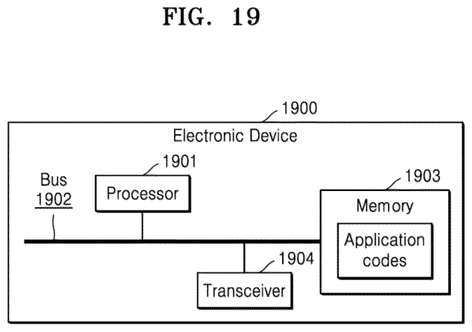

FIG. 19 shows a schematic structure diagram of an electronic device to which an embodiment of the present disclosure may be applied. As shown in FIG. 19, the electronic device 1900 shown in FIG. 19 may include a processor 1901 and a memory 1903. The processor 1901 is connected to the memory 1903, for example, through a bus 1902. In an embodiment, the electronic device 1900 may further include a transceiver 1904, and the transceiver 1904 may be used for data interaction between the electronic device and other electronic devices, such as data transmission and/or data reception. It should be noted that, in practical disclosures, the transceiver 1904 is not limited to one, and the illustrated structure of the electronic device 1900 is not intended to be a limitation to embodiments of the present disclosure. In an embodiment, the electronic device may be a first network node, a second network node or a third network node.

The processor 1901 may be a CPU, a general-purpose processor, a Digital Signal Processor (DSP), an Application Specific Integrated Circuit (ASIC), a Field Programmable Gate Array (FPGA) or other programmable logic devices, transistor logic devices, hardware components, or any combination thereof. It may implement or execute the various exemplary logical blocks, modules and circuits described in connection with this disclosure. The processor 1901 may also be a combination that implements computing functions, such as a combination of one or more microprocessors, a combination of a DSP and a microprocessor, and the like.

The bus 1902 may include a path to transfer information between the components described above. The bus 1902 may be a Peripheral Component Interconnect (PCI) bus or an Extended Industry Standard Architecture (EISA) bus or the like. The bus 1902 may be divided into an address bus, a data bus, a control bus, and the like. For ease of representation, only one thick line is shown in FIG. 19, but it does not mean that there is only one bus or one type of bus.

The memory 1903 may be a Read Only Memory (ROM) or other types of static storage devices that may store static information and instructions, a Random Access Memory (RAM) or other types of dynamic storage devices that may store information and instructions, and may also be Electrically Erasable Programmable Read Only Memory (EEPROM), Compact Disc Read Only Memory (CD-ROM) or other optical disk storage, compact disk storage (including compressed compact disc, laser disc, compact disc, digital versatile disc, blue-ray disc, etc.), magnetic disk storage media, other magnetic storage devices, or any other medium capable of carrying or storing computer programs and capable of being read by a computer, without limitation.

The memory 1903 is used for storing computer programs for executing embodiments of the present disclosure, and the execution is controlled by the processor 1901. The processor 1901 is configured to execute the computer programs stored in the memory 1903 to implement the steps shown in the foregoing method embodiments.

Embodiments of the present disclosure provide a computer-readable storage medium having a computer program stored on the computer-readable storage medium, the computer program, when executed by a processor, implements the steps and corresponding contents of the foregoing method embodiments.

Embodiments of the present disclosure also provide a computer program product including a computer program, the computer program when executed by a processor realizing the steps and corresponding contents of the preceding method embodiments.

The terms “first”, “second”, “third”, “fourth”, “1”, “2”, etc. (if present) in the specification and claims of this disclosure and the accompanying drawings above are used to distinguish similar objects and need not be used to describe a particular order or sequence. It should be understood that the data so used is interchangeable where appropriate so that embodiments of the present disclosure described herein may be implemented in an order other than that illustrated or described in the text.

It should be understood that while the flow diagrams of embodiments of the present disclosure indicate the individual operational steps by arrows, the order in which these steps are performed is not limited to the order indicated by the arrows. Unless explicitly stated herein, in some implementation scenarios of embodiments of the present disclosure, the implementation steps in the respective flowcharts may be performed in other orders as desired. In addition, some, or all of the steps in each flowchart may include multiple sub-steps or multiple phases based on the actual implementation scenario. Some or all of these sub-steps or stages may be executed at the same moment, and each of these sub-steps or stages may also be executed at different moments separately. The order of execution of these sub-steps or stages may be flexibly configured according to requirements in different scenarios of execution time, and embodiments of the present disclosure are not limited thereto.

The above description and accompanying drawings are provided as examples to assist the reader in understanding the present disclosure. They are not intended and should not be construed as limiting the scope of the present disclosure in any way. Although certain embodiments and examples have been provided, based on what is disclosed herein, it will be apparent to those skilled in the art that the particular embodiments and examples discussed and shown herein may be altered without departing from the scope of the present disclosure. Employing other similar means of implementation based on the technical ideas of the present disclosure also fall within the scope of protection of embodiments of the present disclosure.

In an embodiment, the second threshold may include the threshold size of the fifth image.

In an embodiment, the third threshold may include the threshold area of the target restoration region.

In an embodiment, the fourth threshold may include the threshold length of the target restoration region.

In an embodiment, the fifth threshold may include the threshold area of the target restoration region.

In an embodiment, the size of the fifth image may include the width of the fifth image and the height of the fifth image.

In an embodiment, the area of the target restoration region may include the calculation result of the width of the target restoration region and height of the target restoration region.

In an embodiment, the length of the target restoration region may include the at least one of the width of the target restoration region or height of the target restoration region.

In an embodiment, the missing region may include the target restoration region.

In an embodiment, the mask image may include the image comprising the target restoration region.

In an embodiment, the updated fifth image may include the fifth image fused with the restored image by the clipped image.

In an embodiment, the updated target restoration region may include the target restoration region in the updated fifth image.

According to an embodiment of the disclosure, a method may include receiving a first instruction to select a target restoration region in a third image, the third image comprising the second image before the target restoration region is removed. The method may include determining, based on the first instruction, the target restoration region and the second image comprising the target restoration region.

According to an embodiment of the disclosure, a method may include receiving a first instruction from a user to select a target restoration region in a third image, the third image comprising the second image before the target restoration region is removed. The method may include determining, based on the first instruction, the target restoration region and the second image comprising the target restoration region.

According to an embodiment of the disclosure, a method may include determining target restoration content information corresponding to the target restoration region. The method may include performing, based on the target restoration content information, the at least one first denoising process on the first image using the first AI network.

The target restoration content information may include a content feature map corresponding to a target restoration content.

According to an embodiment of the disclosure, a method may include providing class information about restoration contents. The method may include receiving a second instruction to select target class information. The method may include determining, based on the second instruction, the target restoration content information.

According to an embodiment of the disclosure, a method may include providing class information about restoration contents to the user. The method may include receiving a second instruction from the user to select target class information. The method may include determining, based on the second instruction, the target restoration content information.

According to an embodiment of the disclosure, the target restoration content information may comprise a content feature map corresponding to a target restoration content.

According to an embodiment of the disclosure, a method may include using the at least one attention module. The method may include determining an attention between a noise feature map corresponding to the first image and the target restoration content information, the attention representing a degree of denoising the noise feature map according to the target restoration content information. The method may include performing the at least one first denoising process on the first image based on the attention.

According to an embodiment of the disclosure, a method may include using the at least one attention module. The method may include determining an attention between a noise feature map corresponding to the first image and the target restoration content information using a Fourier transform, the attention representing a degree of denoising the noise feature map according to the target restoration content information. The method may include performing the at least one first denoising process on the first image based on the attention.

According to an embodiment of the disclosure, a method may include performing a fast Fourier transform on the noise feature map corresponding to the first image and the target restoration content information to obtain a Fourier feature map. The method may include performing a first convolution operation on the Fourier feature map to obtain a Fourier space query feature, a Fourier space key feature and a Fourier space value feature. The method may include performing a second convolution operation on the Fourier space query feature and the Fourier space key feature to obtain a first attention weight coefficient. The method may include performing an inverse fast Fourier transform on the first attention weight coefficient to obtain a second attention weight coefficient. The method may include obtaining the attention based on the first attention weight coefficient and the Fourier space value feature.

According to an embodiment of the disclosure, a method may include performing a first denoising process on the first image iteratively using at least one first AI network. The method may include extracting a first feature map corresponding to the first denoising result and a second feature map corresponding to a third image added with a predetermined proportion of noise, the third image the second image before the target restoration region is removed. The method may include determining, based on a similarity between the first feature map and the second feature map, whether to iteratively use the at least one first AI network to perform the first denoising process.

According to an embodiment of the disclosure, a method may include performing a first denoising process on the first image iteratively using at least one first AI network. The method may include based on a processing result output by the at least one first AI network, extracting a first feature map corresponding to the processing result and a second feature map corresponding to a third image added with a predetermined proportion of noise, the third image the second image before the target restoration region is removed. The method may include based on the processing result output by the at least one first AI network, determining, based on a similarity between the first feature map and the second feature map, whether to iteratively use the at least one first AI network to perform the first denoising process.

According to an embodiment of the disclosure, a method may include using a third AI network, extracting, from the first denoising result, first feature maps of at least two layers. The method may include determining an autocorrelation coefficient of the first feature maps. The method may include using the third AI network, extracting, from the third image added with a predetermined proportion of noise, second feature maps of at least two layers. The method may include determining an autocorrelation coefficient of the second feature maps. The method may include determining a distance between the autocorrelation coefficient of the first feature maps and the autocorrelation coefficient of the second feature maps. The method may include determining, based on a relationship between the distance and a first threshold, whether to iteratively use the at least one first AI network for the first denoising process.

According to an embodiment of the disclosure, a method may include using a third AI network, extracting, from the processing result, first feature maps of at least two layers. The method may include determining an autocorrelation coefficient of the first feature maps. The method may include using the third AI network, extracting, from the third image added with a predetermined proportion of noise, second feature maps of at least two layers. The method may include determining an autocorrelation coefficient of the second feature maps. The method may include determining a distance between the autocorrelation coefficient of the first feature maps and the autocorrelation coefficient of the second feature maps. The method may include determining, based on a relationship between the distance and a first threshold, whether to iteratively use the at least one first AI network for the first denoising process.

According to an embodiment of the disclosure, a method may include performing a second denoising process on the first denoising result to obtain a second denoising result. The method may include determining texture information included in the second image based on a region that is not to be restored. The method may include extracting a third feature map corresponding to the target restoration region in the second denoising result. The method may include restoring the target restoration region based on the texture information and the third feature map to obtain the restored image.

According to an embodiment of the disclosure, a method may include dividing a feature map corresponding to the texture information and the third feature map into image blocks having a same size to obtain first sub-feature maps and second sub-feature maps. The method may include calculating a similarity between each first sub-feature map and each second sub-feature map to obtain an adaptive weight corresponding to each pair of first and second sub-feature maps. The method may include fusing each first sub-feature map corresponding to each second sub-feature map with the corresponding adaptive weight to obtain texture-enhanced second sub-feature maps. The method may include restoring the target restoration region based on the texture-enhanced second sub-feature maps to obtain the restored image.

According to an embodiment of the disclosure, a method may include performing element point addition on each second sub-feature map and the target restoration region of the second denoising result to obtain the restored image.

According to an embodiment of the disclosure, a method may include extracting, from the first denoising result, a fourth feature map of at least one previous layer using a third AI network. The method may include performing a third convolution operation on the second image and the fourth feature map to determine non-texture information included in the second image based on the region that is not to be restored. The method may include determining the texture information included in the second image based on the second image and the non-texture information included in the second image.

According to an embodiment of the disclosure, a method may include performing a corresponding number of down-sampling operations and up-sampling operations on the second image to obtain the non-texture information included in the second image. The element point averaging may be performed on a result of the at least one down-sampling operation and the fourth feature map of the corresponding scale to obtain an average feature map. A next down-sampling operation or up-sampling operation may be performed on the average feature map.

According to an embodiment of the disclosure, a method may include acquiring a fifth image comprising the target restoration region. The method may include based on a size of the fifth image being greater than a second threshold, acquiring the second image from the fifth image. The method may include acquiring the second image from the fifth image by performing based on an area of the target restoration region being less than a third threshold and a length of the target restoration region being less than a fourth threshold, clipping the fifth image into a clipped image having the size equal to the second threshold using the target restoration region as a center to obtain the second image. The method may include acquiring the second image from the fifth image by performing based on the area of the target restoration region being less than the third threshold and the length of the target restoration region being greater than the fourth threshold, or based on the area of the target restoration region being greater than the third threshold, determining an image region in the fifth image in which the size of the image region is equal to the second threshold and an area of the target restoration region in the image region is not greater than a fifth threshold, clipping the image region into the clipped image to obtain the second image, and using the target restoration region in the image region as the target restoration region of the second image.

According to an embodiment of the disclosure, a method may include fusing the clipped image with the restored target restoration region corresponding to the image region into the fifth image to obtain an updated fifth image having an updated target restoration region. The method may include acquiring the second image based on the updated fifth image having the updated target restoration region.

According to an embodiment of the disclosure, the first AI network may comprise a diffusion network.

According to an embodiment of the disclosure, a method may include acquiring a target restoration region selected in an image by a user. The method may include providing class information of about restoration contents to the user. The method may include acquiring target class information selected by the user. The method may include restoring, based on the target class information selected by the user, the target restoration region in the image by using a first AI network to obtain a first restoration result. The method may include restoring the first restoration result of the first AI network by using a second AI network to obtain a restored image. The method may include providing the restored image to the user.

According to an embodiment of the disclosure, a method may include acquiring a first image that is obtained by adding noise to a second image, the second image comprising a target restoration region. The method may include determining an attention corresponding to the first image with a Fourier transform using an attention module, the attention representing a degree of denoising for the first image. The method may include performing at least one denoising process on the first image based on the attention to obtain an image having the restored target restoration region.

According to an embodiment of the disclosure, an electronic device comprising a memory, at least one processer is provided. The one or more processor is configured to perform a first denoising process on the first image iteratively using at least one first AI network. The one or more processor is configured to extract a first feature map corresponding to the first denoising result and a second feature map corresponding to the third image added with a predetermined proportion of noise. The one or more processor is configured to determine, based on a similarity between the first feature map and the second feature map, whether to iteratively use the at least one first AI network to perform the first denoising process.

What is claimed is:

1. A method executed by an electronic device, the method comprising:
acquiring a first image that is obtained by adding noise to a second image, the second image comprising a target restoration region;
performing at least one first denoising process on the first image using a first artificial intelligence (AI) network to obtain a first denoising result; and
restoring the target restoration region based on the first denoising result using a second AI network to obtain a restored image.

2. The method according to claim 1, further comprising:
receiving a first instruction to select a target restoration region in a third image, the third image comprising the second image before the target restoration region is removed; and
determining, based on the first instruction, the target restoration region and the second image comprising the target restoration region.

3. The method according to claim 2, wherein the performing the at least one first denoising process comprises:
determining target restoration content information corresponding to the target restoration region; and
performing, based on the target restoration content information, the at least one first denoising process on the first image using the first AI network.

4. The method according to claim 3, wherein the determining the target restoration content information comprises:
providing class information about restoration contents;
receiving a second instruction to select target class information; and
determining, based on the second instruction, the target restoration content information.

5. The method according to claim 3, wherein the target restoration content information comprises a content feature map corresponding to a target restoration content.

6. The method according to claim 3, wherein the first AI network comprises at least one attention module, and
wherein the performing the at least one first denoising process comprises:
using the at least one attention module, determining an attention between a noise feature map corresponding to the first image and the target restoration content information, the attention representing a degree of denoising the noise feature map according to the target restoration content information, and
performing the at least one first denoising process on the first image based on the attention.

7. The method according to claim 6, wherein the determining the attention comprises:
performing a fast Fourier transform on the noise feature map corresponding to the first image and the target restoration content information to obtain a Fourier feature map;
performing a first convolution operation on the Fourier feature map to obtain a Fourier space query feature, a Fourier space key feature and a Fourier space value feature;
performing a second convolution operation on the Fourier space query feature and the Fourier space key feature to obtain a first attention weight coefficient;
performing an inverse fast Fourier transform on the first attention weight coefficient to obtain a second attention weight coefficient; and
obtaining the attention based on the first attention weight coefficient and the Fourier space value feature.

8. The method according to claim 1, wherein the performing the at least one first denoising process comprises:
performing a first denoising process on the first image iteratively using at least one first AI network;
extracting a first feature map corresponding to the first denoising result and a second feature map corresponding to a third image added with a predetermined proportion of noise, the third image the second image before the target restoration region is removed; and
determining, based on a similarity between the first feature map and the second feature map, whether to iteratively use the at least one first AI network to perform the first denoising process.

9. The method according to claim 8, wherein the extracting the first feature map comprises: using a third AI network, extracting, from the first denoising result, first feature maps of at least two layers, and determining an autocorrelation coefficient of the first feature maps;
wherein the extracting the second feature map comprises: using the third AI network, extracting, from the third image added with a predetermined proportion of noise, second feature maps of at least two layers, and determining an autocorrelation coefficient of the second feature maps; and
wherein the determining whether to iteratively use the at least one first AI network for the first denoising process comprises:
determining a distance between the autocorrelation coefficient of the first feature maps and the autocorrelation coefficient of the second feature maps; and
determining, based on a relationship between the distance and a first threshold, whether to iteratively use the at least one first AI network for the first denoising process.

10. The method according to claim 1, wherein the restoring the target restoration region based on the first denoising result comprises:
performing a second denoising process on the first denoising result to obtain a second denoising result;
determining texture information included in the second image based on a region that is not to be restored;
extracting a third feature map corresponding to the target restoration region in the second denoising result; and
restoring the target restoration region based on the texture information and the third feature map to obtain the restored image.

11. The method according to claim 10, wherein the restoring the target restoration region based on the texture information and the third feature map comprises:
dividing a feature map corresponding to the texture information and the third feature map into image blocks having a same size to obtain first sub-feature maps and second sub-feature maps;
calculating a similarity between each first sub-feature map and each second sub-feature map to obtain an adaptive weight corresponding to each pair of first and second sub-feature maps;
fusing each first sub-feature map corresponding to each second sub-feature map with the corresponding adaptive weight to obtain texture-enhanced second sub-feature maps; and
restoring the target restoration region based on the texture-enhanced second sub-feature maps to obtain the restored image.

12. The method according to claim 11, wherein the restoring the target restoration region based on the texture-enhanced second sub-feature maps comprises:
performing element point addition on each second sub-feature map and the target restoration region of the second denoising result to obtain the restored image.

13. The method according to claim 10, wherein the determining the texture information included in the second image comprises:
extracting, from the first denoising result, a fourth feature map of at least one previous layer using a third AI network;
performing a third convolution operation on the second image and the fourth feature map to determine non-texture information included in the second image based on the region that is not to be restored; and
determining the texture information included in the second image based on the second image and the non-texture information included in the second image.

14. The method according to claim 13, wherein the performing the third convolution operation on the second image and the fourth feature map comprises:
performing a corresponding number of down-sampling operations and up-sampling operations on the second image to obtain the non-texture information included in the second image, and
wherein, for at least one down-sampling operation, element point averaging is performed on a result of the at least one down-sampling operation and the fourth feature map of the corresponding scale to obtain an average feature map, and a next down-sampling operation or up-sampling operation is performed on the average feature map.

15. The method according to claim 1, wherein before the acquiring the first image, the method further comprises:
acquiring a fifth image comprising the target restoration region;
based on a size of the fifth image being greater than a second threshold, acquiring the second image from the fifth image by performing at least one of:
based on an area of the target restoration region being less than a third threshold and a length of the target restoration region being less than a fourth threshold, clipping the fifth image into a clipped image having the size equal to the second threshold using the target restoration region as a center to obtain the second image; or
based on the area of the target restoration region being less than the third threshold and the length of the target restoration region being greater than the fourth threshold, or based on the area of the target restoration region being greater than the third threshold, determining an image region in the fifth image in which the size of the image region is equal to the second threshold and an area of the target restoration region in the image region is not greater than a fifth threshold, clipping the image region into the clipped image to obtain the second image, and using the target restoration region in the image region as the target restoration region of the second image.

16. The method according to claim 15, further comprising:
fusing the clipped image with the restored target restoration region corresponding to the image region into the fifth image to obtain an updated fifth image having an updated target restoration region; and
acquiring the second image based on the updated fifth image having the updated target restoration region.

17. The method according to claim 1, wherein the first AI network comprises a diffusion network.

18. An electronic device comprising:
a memory configured to store instructions; and
at least one processor configured to execute the instructions to:
acquire a first image that is obtained by adding noise to a second image, the second image comprising a target restoration region;
perform at least one first denoising process on the first image using a first artificial intelligence (AI) network to obtain a first denoising result; and
restore the target restoration region based on the first denoising result using a second AI network to obtain a restored image.

19. The electronic device according to claim 18, wherein at least one processor further configured to execute the instructions to:
perform a first denoising process on the first image iteratively using at least one first AI network;
extract a first feature map corresponding to the first denoising result and a second feature map corresponding to the third image added with a predetermined proportion of noise; and
determine, based on a similarity between the first feature map and the second feature map, whether to iteratively use the at least one first AI network to perform the first denoising process.

20. A non-transitory computer-readable storage medium storing instructions which, when executed by at least one processor, cause the at least one processor to:
acquire a first image that is obtained by adding noise to a second image, the second image comprising a target restoration region;
perform at least one first denoising process on the first image using a first artificial intelligence (AI) network to obtain a first denoising result; and
restore the target restoration region based on the first denoising result using a second AI network to obtain a restored image.
